(19) United States
(12) Patent Application Publication
(10) Pub. No.: US 2004/0096368 A1
(43) Pub. Date: May 20, 2004

(54) Assay systems and components

(75) Inventors: Charles Quentin Davis, Frederick, MD (US); Richard A. Cook, Derwood, MD (US)

Correspondence Address: KRAMER LEVIN NAFTALIS & FRANKEL LLP, INTELLECTUAL PROPERTY DEPARTMENT, 919 THIRD AVENUE, NEW YORK, NY, 10022, US

(73) Assignee: IGEN International, Inc.

(21) Appl. No.: 10/600,165

(22) Filed: Jun. 19, 2003

Related U.S. Application Data
(60) Provisional application No. 60/392,399, filed on Jun. 28, 2002.

(51) Int. Cl. B01L 9/00

(52) U.S. Cl. 422/104

(57) ABSTRACT

Assay systems and components, and methods of using same. The assay system preferably includes one or more of the following components: i) an apparatus for retaining/positioning an assay plate; ii) a device for detecting proper alignment of an assay plate; iii) an apparatus for training a probe to locate and aspirate reagents and/or one or more samples; iv) a fluid handling device for aspirating reagents; v) an apparatus for detecting the presence/absence of a reagent comprising a fluid handling manifold having both a transparent light path and a fluid conduit defined therein and vi) a positive displacement pump having a pump chamber improved to contain one or more of: bypass means; cleanout means; and/or gas and sediment removal means.

### RELATED APPLICATION

This patent application claims benefit from U.S. Provisional Patent Application No. 60/392,399, entitled: “Assay Systems and Components”, filed Jun. 28, 2002.

### FIELD OF THE INVENTION

The present invention relates to improved assay apparatuses and components thereof. The invention also relates to improved pumps, fluidic manifolds and alignment mechanisms for use in assay systems or other applications. In addition, the invention relates to methods of using theses assay apparatuses and components, e.g., when carrying out assays.

### BACKGROUND OF THE INVENTION

Biological detection systems may include fluidic systems for moving and mixing samples and reagents. In many applications, the samples and reagents may include complex matrices that may contain salts, air bubbles and/or particulate matter that can reduce the performance or damage fluidic systems. It is desirable that fluidic systems used in biological detection systems are capable of handling such complex matrices. At the same time, it is desirable that fluidic systems have relatively low complexity so as to increase the reliability and robustness of the systems and reduce cost.

Many biological detection systems employ multi-well plates as sample and/or reagent carriers so as to allow for greater automation of assay procedures and to increase assay throughput. It is important that biological detection systems be able to correctly identify and/or interrogate specific wells on plate. Misalignment of plates or instrument components can lead to interrogation of incorrect wells and spurious results and may also lead to instrument damage. Improved methods and devices for aligning plates and instrument components are needed.

### SUMMARY OF THE INVENTION

In one embodiment, an apparatus for retaining a plate that may have any one of a plurality of different predetermined flange heights is disclosed. The apparatus preferably comprises a first positioning block having two or more retaining ledges and a retractably mounted first positioning arm. The first positioning arm can have at least one retaining ledge defined thereon. A second positioning block preferably having two or more retaining ledges can be arranged in relation to the first positioning block such that the first and second positioning blocks engagingly receive the plate. The first positioning arm can be adapted to selectively apply a biasing force to the plate to preferably position the plate under at least one of the second positioning block's retaining ledges.

In accordance with another embodiment, an apparatus for positioning a plate in a predetermined plate alignment position is disclosed. The apparatus may comprise a plate loader that can be adapted to loosely receive the plate and preferably translate the plate between first and second positioning blocks that are arranged to engagingly receive the plate. The apparatus preferably includes two or more plate positioning stops arranged in accordance with the predetermined plate alignment position. The first positioning block could include a retractably mounted first positioning arm that is preferably adapted to selectively apply a first biasing force to the plate to position the plate in the predetermined plate alignment position.

At least one of the positioning stops may be arranged on the plate loader to define the predetermined position of the plate along the direction perpendicular to the translation path of the plate loader. Additionally, one of the positioning stops can be arranged on the plate loader to preferably define the predetermined position of the plate along the direction parallel to the translation path. The first biasing force then preferably pushes the plate against the perpendicular positioning stop. The first biasing force could preferably include a frictional component force that can push the plate against the parallel positioning stop. In one embodiment, the plate loader could include at least one horizontal surface for supporting the plate that preferably includes a rim that at least partially defines a perimeter of the horizontal surface and serves as a positioning stop. Alternatively, an arrestment surface can be arranged on a perimeter of the horizontal surface to serve as a positioning stop.

In another embodiment, the second positioning block may further comprise a retractably mounted second positioning arm that is preferably adapted to apply a second biasing force to the plate that is lesser in magnitude than the first biasing force. The second positioning arm could include at least one retaining ledge defined thereon. Still further, the first positioning block could comprise a retractably mounted third positioning arm having at least one retaining ledges defined thereon. Still even further, at least one retaining ledge can be defined on the first and second positioning blocks.

According to a still further embodiment, an apparatus that can both position and retain a plate, which may have any one of a plurality of different predetermined flange heights, in a predetermined plate alignment position is disclosed. The apparatus preferably includes first and second positioning blocks, a plate loader and two or more positioning stops. The two or more plate positioning stops are preferably arranged in accordance with the predetermined plate alignment position. The first positioning block preferably comprises a retractably mounted first positioning arm and two or more retaining ledges wherein at least one of the retaining ledges can be defined on the first positioning arm. The second positioning block preferably includes two or more retaining ledges. The plate loader is preferably adapted to loosely receive the plate and to translate the plate between the first and second positioning blocks that are preferably arranged to engagingly receive the plate. The first positioning arm is preferably adapted to selectively apply a first biasing force to the plate to position the plate in the predetermined plate alignment position under at least one of the second positioning block's retaining ledges.

In accordance with another aspect of the invention, a device for confirming proper alignment of a plate is disclosed. The device preferably comprises a sensor and a retractable lever arm arranged within the sensor housing. First and second spring members are preferably arranged between a surface of the sensor housing and the first lever arm so as to apply biasing forces at first and second ends of-the lever. The sensor is preferably positioned in relation to the lever arm so that each lever end must be displaced at least a predetermined distance by the plate in order to actuate the sensor, indicating the plate is properly positioned. The first and second lever ends can also: include first and second lever projections for contacting the plate.

In another embodiment, the device can comprise one or more first and second lever end stops preferably arranged to restrict the displacement of the first and second lever ends between first and second lever end minimums and maximums.

In a still further embodiment, the sensor housing preferably includes a second retractable lever arm having third and fourth lever ends. Third and fourth spring members are preferably arranged between the housing surface and the second lever arm so as to apply biasing forces at the third and fourth lever ends, respectively. The second retractable lever arm can be positioned in relation to the first lever end of the first arm so that each of the third and fourth lever ends must be displaced at least a predetermined distance by the plate in order to displace the first lever end by at least the first predetermined distance.

In accordance with another aspect of the invention, an apparatus for training a probe to locate and aspirate reagents and/or one or more samples is disclosed. The apparatus includes a movable probe, a motion control system for moving the probe and a fixed object having an alignment feature. The alignment feature is adapted to receive the probe and preferably comprises a first opening having at least one first opening side enclosing a first opening area and a second opening having at least one second opening side enclosing a second opening area. The first opening area is preferably greater than the second opening area and the first and second openings are concentrically arranged. Further, the relative arrangement of the first and second openings to one another preferably defines the guiding angle of a guiding surface of the alignment feature. Alternatively, in another embodiment, the second opening can be sized to closely receive the probe and can be arranged below, and connected by the guiding surface to, the first opening.

In another embodiment, the apparatus may include a motion control system for controlling movement of the probe in at least a first direction along, and at least a second direction perpendicular to, the probe axis. The alignment feature can alternatively comprise a first opening sized in accordance with a fabrication tolerance of the apparatus and at least one guiding surface having at least one guiding angle. The motion control system can preferably be configured to (i) move the probe in the second direction to within an initial estimate of the alignment feature, (ii) release control of the probe so as to allow it to move freely in the second direction, and (iii) move the probe in the first direction into the alignment feature such that the guiding surface guides the probe into precise alignment. The guiding surface can be conical, trapezoidal, doubly curved, or the like.

According to another aspect, a method of training a probe to locate and aspirate reagents and/or one or more samples within a biological detection device using the alignment feature is disclosed. The method preferably comprises moving the probe to an initial estimated position of the alignment feature, in at least a first direction along, and at least a second direction perpendicular to, the probe axis. Control of the probe's motion in the second direction is then released and the probe is preferably advanced a predetermined distance in the first direction, contacting the guiding surface and being guided in the second direction into the actual position of the alignment feature. The method can also comprise withdrawing the probe, reactivating control of the probe's motion in the second direction, homing the probe, determining a calibration distance traveled in the second direction and then determining an actual position of the alignment feature in accordance with the initial estimated position and the calibrated distance.

In an another embodiment, the training method preferably employs a computerized motion control system, which has a processor and a memory, to control the probe's motion. A set of probe training instructions adapted to control the probe's motion can preferably be stored in the memory. The probe training instructions can include one or more sets of refinement instructions that are preferably adapted to cause the probe to perform one or more refinement measurements at one or more refinement positions. The refinement instructions can use the actual position of the alignment feature and the fabrication tolerance to determine the one or more refinement positions and the training method can be repeated at each of the refinement positions.

In accordance with yet another aspect of the invention, a fluid handling device for aspirating reagents is disclosed. The device preferably includes a reagent manifold that comprises an aspiration chamber, two or more reagent input lines, a gas input line, a reagent manifold sealing surface and a movable probe. The aspiration chamber diameter is preferably larger than the probe diameter and the aspiration chamber height is preferably substantially the same as the probe height. The aspiration chamber preferably has an access port and is defined within the reagent manifold. The plurality of reagent input lines are preferably arranged at substantially the same height and the gas input line is preferably arranged above the reagent input lines. The reagent input and gas input lines are preferably adapted to be in selective fluid communication with the aspiration chamber. The movable probe includes a probe tip and preferably a probe sealing surface that is adapted to sealingly engage the reagent manifold sealing surface when the probe is lowered into the aspiration chamber. In another embodiment, a seal configured to enclose the access port and to form a face seal when the probe is lowered into the aspiration chamber is employed. The seal can be a an o-ring, a gasket, or an elastomeric material and can be either arranged on the probe sealing surface or the reagent manifold sealing surface. The seal is preferably arranged within a groove of the appropriate sealing surface.

In another embodiment, a plurality of independently controlled valves for selectively placing each reagent line in fluid communication with the aspiration chamber is preferably employed.

According to another aspect of the invention, an apparatus for detecting the presence/absence of a reagent having a reagent index of refraction is disclosed. The apparatus preferably comprises a fluid handling manifold, a light source and a light detector. The fluid handling manifold includes an exterior, a transparent light path defined therein and a fluid conduit defined therein. Preferably, at least a portion of the fluid conduit includes first and second planar fluid interface surfaces that intersect, and are arranged at fluid interface angles relative to, the light path. The light source is adapted to preferably direct light into, and the light detector is preferably configured to detect light transmitted through, the light path. The fluid handling manifold can be adapted to preferably include an exterior having first and second planar exterior surfaces that intersect the light path. The first and second exterior surfaces may also be preferably arranged to be substantially parallel. Still further, the first and second exterior surfaces can preferably be arranged to be substantially perpendicular to the light path. In other embodiments, the first and second fluid interfaces are substantially parallel.

The fluid handling manifold preferably consists of a substantially transparent material having an index of refraction that is greater than the index of refraction of air, more preferably greater than or equal to the reagent index of refraction and still more preferably greater than 1.4. The substantially transparent material can be Lexan, acrylic, polycarbonate, Perspex, Lucite, Acrylite or polystyrene.

According to one embodiment, the light source would preferably be positioned to direct light at the first fluid interface surface at an angle of intersection greater than the critical reflectivity angle when air is present in the fluid conduit. Alternatively, the angle Of intersection of the light directed at the first interface surface can be such that it results in less than about twenty percent (20%) of the light being reflected at the first interface surface when the reagent is present in the fluid conduit.

In yet another embodiment, a control system can be employed that is preferably adapted to send/receive control signals to/from the light detector and the light source. Additionally, the control system can be adapted to process the light generation signal and control an assay device.

In accordance with another aspect of the invention, an improved positive displacement pump is disclosed. The pump comprises a pump chamber interface line, a first fluid line, a second fluid line, a 3-way valve and a bypass line. The 3-way valve preferably has a first port, a second port and a common port, wherein the first port is linked to the first fluid line, the second port is linked to the second fluid line and the common port is linked to the pump interface line. Further, the 3-way valve is preferably operable to place either the first fluid line or the second fluid line in fluid communication with the pump interface line. The bypass line is preferably linked to the first fluid line and the second fluid line and includes a bypass shut-off valve that is operable to selectively link the first fluid line and the second fluid line. In one embodiment, the bypass valve, when open, allows the first and second fluid lines to be flushed without operation of the pump. The first and second fluid lines can be an input line and an output line, respectively.

In accordance with another aspect of the invention, a positive displacement pump having an improved pump chamber is disclosed. The pump chamber preferably comprises a first opening adapted to receive a pump piston, a second opening from which the pump aspirates and dispenses fluid, a pump chamber cleanout opening and a cleanout plug for sealingly engaging the pump chamber cleanout opening. Removal of the cleanout plug preferably allows the pump chamber to be flushed without operation of the pump. The first opening may also comprise a fluidic seal between the pump piston and the first opening.

In one embodiment, the second opening and the pump chamber cleanout opening are spaced substantially at opposite ends, of the pump chamber. In another embodiment, the pump cleanout opening provides a fluid path that is substantially tangent to the interior wall of the pump chamber. In a still further embodiment, the pump comprises a piston.

In accordance with another aspect of the invention, a positive displacement pump having an improved pump chamber is disclosed. The pump chamber preferably comprises a first opening adapted to receive a pump piston, a gas trap, a sediment trap, a first fluid line linked to the gas trap and a second fluid line linked to the sediment trap. The first and second fluid lines are preferably sized relative to one another such that the fluidic resistance of gas through the first fluid line is less than the fluidic resistance of liquid through the second fluid line, and the fluidic resistance of liquid through the first fluid line is greater than, or equal to, the fluidic resistance of liquid through the second fluid line.

In one embodiment, the gas trap may be an angled groove along the top surface of the chamber and is preferably arranged so that the first fluid line is linked to the topmost portion of the groove. In another embodiment, the sediment trap can be an angled groove along the bottom surface of the chamber and is preferably arranged so that the second fluid line is linked to the bottommost portion of the groove. In yet another embodiment, the first and second fluid lines are preferably connected directly to a single fluid interface line.

### BRIEF DESCRIPTION OF THE DRAWINGS

FIG. 1a is a schematic representation of one embodiment for a flow-cell based biological detection system.

FIG. 1b is an oblique view of a plate holding apparatus.

FIG. 1c is a cross sectional, view of positioning blocks used in a plate holding apparatus.

FIG. 1d illustrates the effect of extracting a fluidic probe from a well of a sealed microtiter plate that is held in a plate holding apparatus.

FIGS. 1e-1g provides illustrations of three different standard sized microtiter plates loaded into a plate holding apparatus.

FIG. 1h provides a cross-sectional view of a positioning block used in a plate holding apparatus.

FIG. 1i provides a detailed top view of a positioning block used in a plate holding apparatus.

FIG. 2a depicts an alignment detection device employing a single sensor to detect two different points.

FIG. 2b illustrates a condition of the alignment detection device of FIG. 2a wherein the sensor is not actuated because proper alignment of the two sensed points has not been achieved.

FIG. 2c illustrates a condition of the alignment detection device of FIG. 2a wherein the sensor is actuated because proper alignment of the two sensed points has been achieved.

FIG. 2d depicts an alignment detection device employing a single sensor to detect three different points.

FIGS. 3a-1, 3a-2, . . . , 3a-10 illustrate several suitable geometries of alignment features useful for calibrating the position of a fluidic probe.

FIG. 3b illustrates the forces applied on a fluidic probe when a probe is lowered onto an angled guiding surface of an alignment feature.

FIGS. 3c-1, 3c-2, and 3c-3 illustrate a preferred procedure for calibrating the position of a fluidic probe.

FIGS. 3d-1, 3d-2 and 3d-3 illustrate how preferred procedures for calibrating the position of a fluidic probe affect the-probes position.

FIG. 4a-c depict cross-sectional (a,b) and oblique views (c) of fluid handling stations employing advantageously arranged and configured reagent lines and a dry face-sealing configuration for a probe.

FIG. 5 illustrates the operational theory of a non-contact reagent detection sensor.

FIG. 6a depicts a reflectance performance curve of the sensor of FIG. 5 for a typical aqueous based reagent and air, wherein the body of the fluid handing station is comprised of acrylic.

FIG. 6b depicts a transmittance performance curve of the sensor of FIG. 5 for a typical aqueous based reagent and air, wherein the body of the fluid handing station is comprised of acrylic.

FIG. 6c is an enlargement of a portion of the transmittance performance curve of FIG. 6b.

FIG. 7 depicts a transmittance performance curve of the sensor of FIG. 5 for two fluids that differ in refractive index by 0.0061, wherein the body of the fluid handing station is comprised of acrylic.

FIG. 8 depicts two cross-sectional views of a modified pump head assembly adapted to provide passive bubble/sediment trapping and evacuation.

FIG. 9 illustrates a modified pump chamber adapted to allow back-flushing of the fluidic system in order to eradicate/remove clogs.

FIG. 10a illustrates a modified pump chamber adapted to provide for decontamination of the pump chamber even in the event of total pump failure.

FIG. 10b depicts a more readily manufacturable adaptation of the modified pump chamber of FIG. 10a.

FIG. 11 illustrates an isometric view of a pump assembly incorporating the features of the modified pump head assembly and modified pump chamber of FIG. 810b.

### DETAILED DESCRIPTION

The invention, as well as additional objects, features and advantages thereof, will be understood more fully from the following detailed description of certain preferred embodiments.

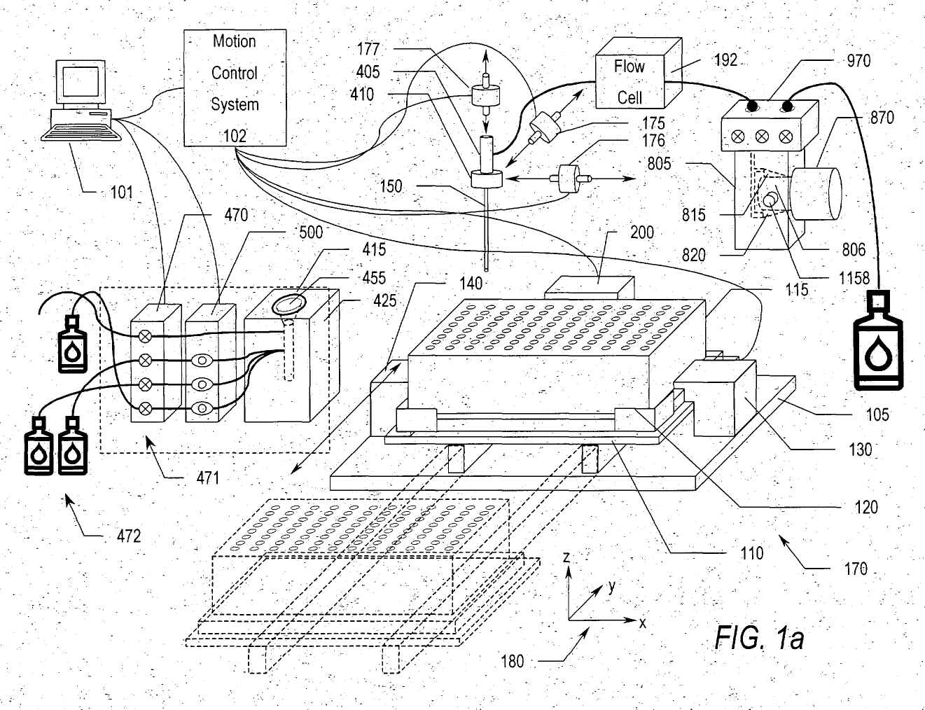

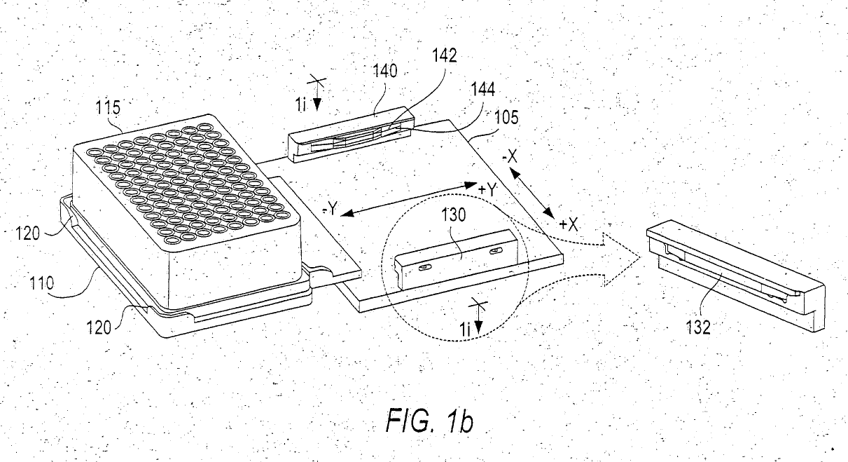

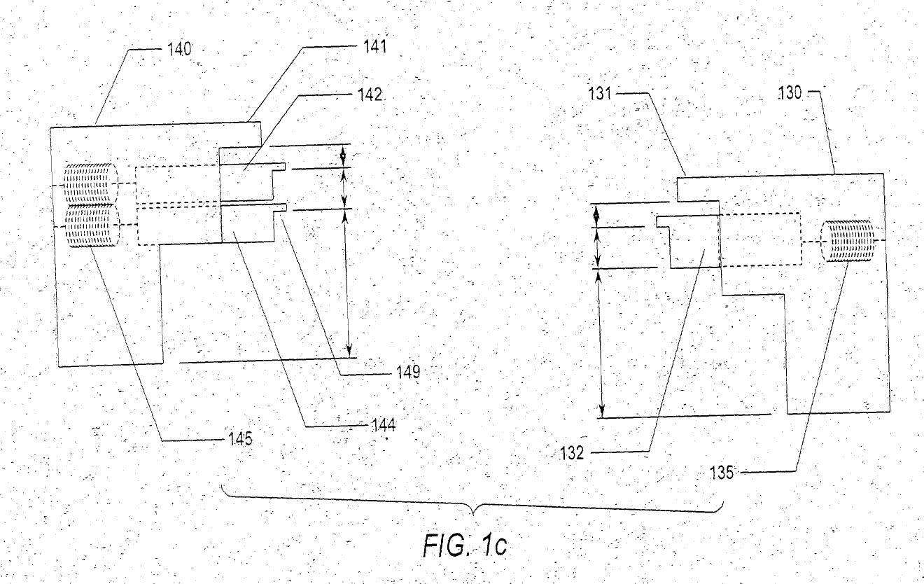

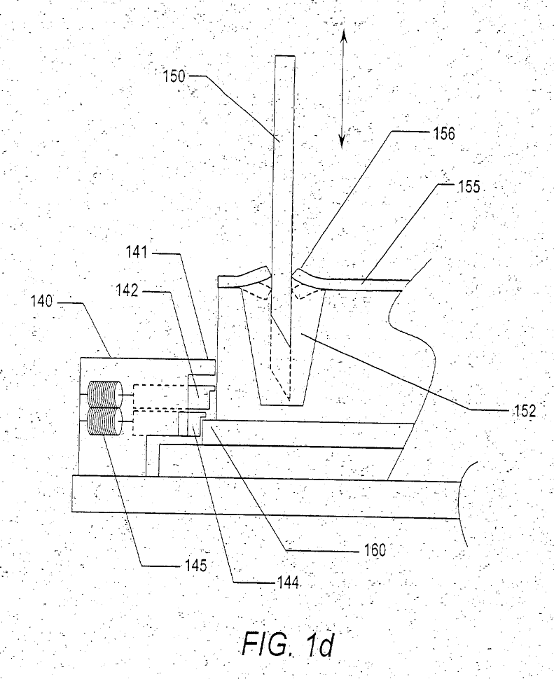

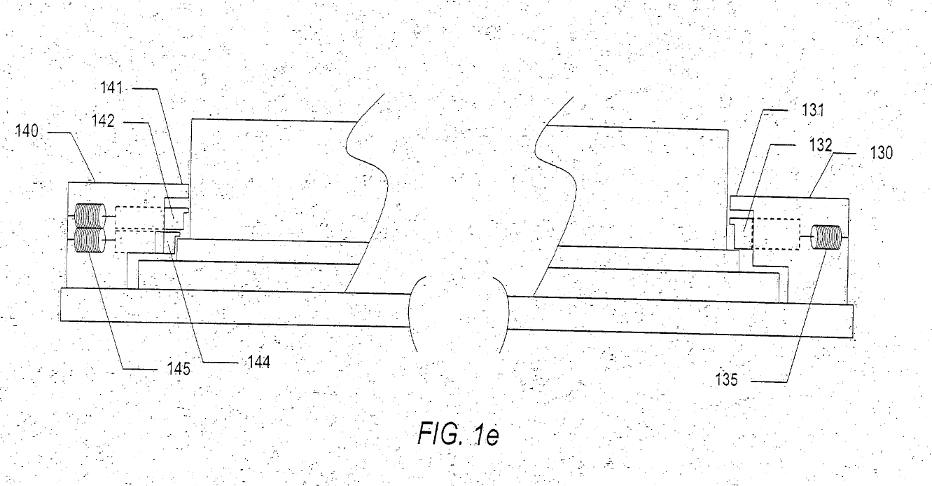

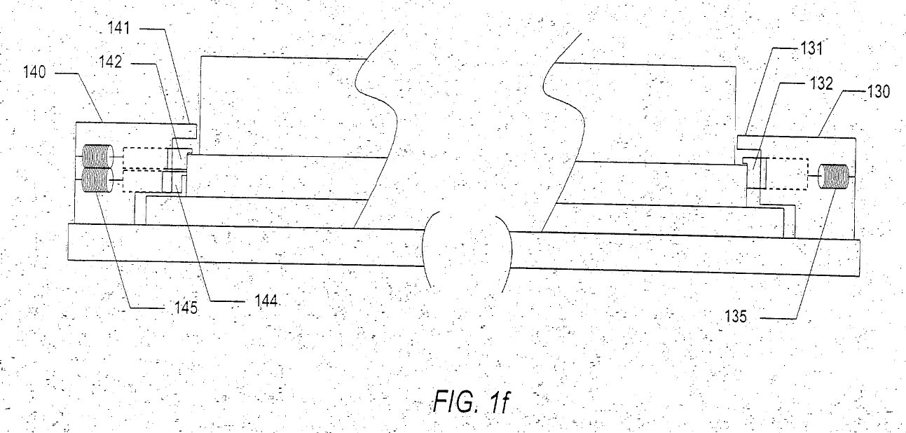

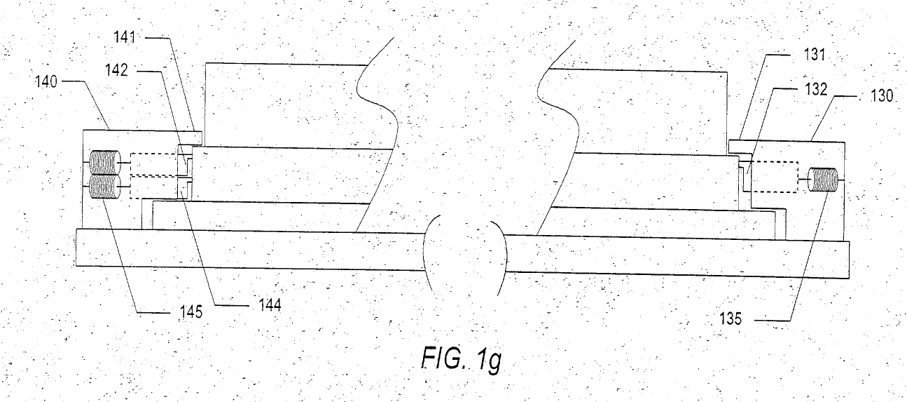

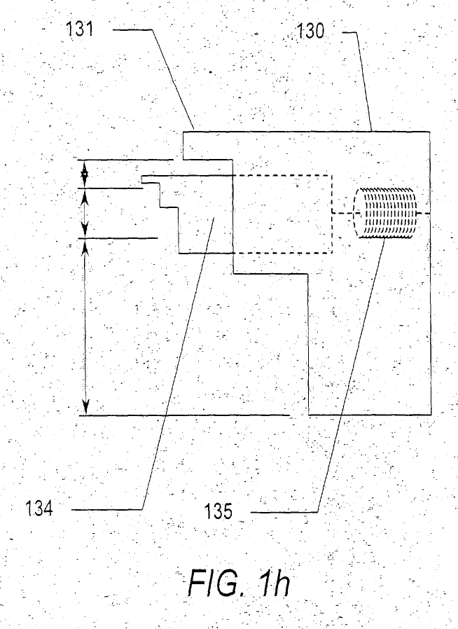

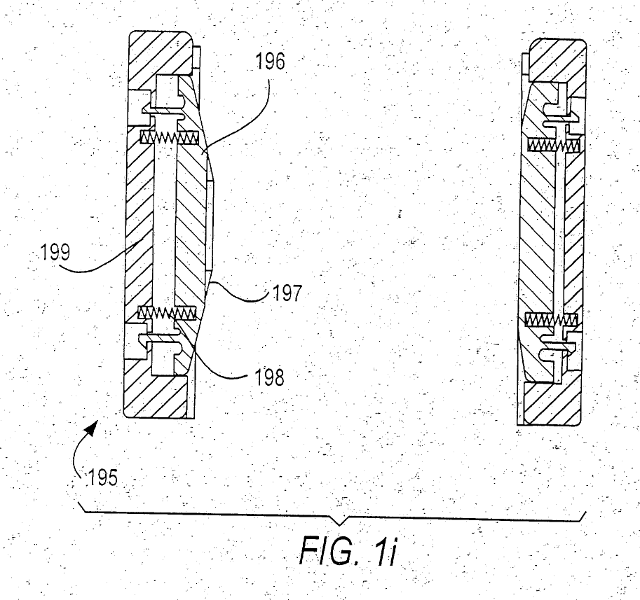

FIG. 1a is a schematic representation of one embodiment for a flow-cell based biological detection system that integrates the various devices, components and/or methods of the present invention. As depicted, overall operation of the biological detection system is preferably conducted under control of a computerized system 101. Sample analysis occurs in flow cell 192 which is preferably adapted for measuring radioactivity, optical absorbance, magnetic or magnetizable materials, light scattering, optical interference (i.e., interferometric measurements), refractive index changes, surface plasmon resonance and/or luminescence (e.g., fluorescence, chemiluminescence and electrochemiuminescence). Preferably, flow cell 192 is adapted for conducting electrochemiluminescence measurements. Suitable electrochemiluminescence flow cells and methods for their use are disclosed in U.S. Pat. No. 6,200,531 B1, the entire disclosure of which is hereby incorporated by reference. The operation of flow cell 192 is, preferably, controlled by computer system 101 which may also receive assay data from flow cell 192 and carry out data analysis.

Various automation systems may be employed such as a plate loader for facilitating proper loading of sample carriers and a pipettor (preferably, a movable pipettor under automated control) for aspirating/dispensing fluids from one or more locations within the system. The plate loader 110 depicted in FIG. 1a is a simple one degree of freedom device that translates a plate linearly from one position (typically outside of the biological detection system's housing) to a second position (typically inside the biological detection system's housing) but may optionally be adapted to have additional degrees of freedom in the vertical direction or in the plane of the plate. The system, however, is not limited to such a plate loader and may utilize any system capable of transporting the sample carrier from a loading point to a point where the carrier is positioned for processing by the system; e.g., a rotary system could be employed wherein the sample carrier is loaded on an arm that rotationally pivots about some point. The automated pipettor 405 shown in FIG. 1a is capable of motion in 3-dimensions within a Cartesian coordinate system through three independently controllable motors 175, 166, 177, however, motion control systems based on alternative coordinate systems may be used (e.g., one dimensional, two dimensional, polar coordinates, etc.). Operation of the automation systems are preferably controlled by a motion control subsystem. As depicted, the motion control subsystem 102 preferably receives instructions from the computerized system 101 which it then converts into appropriate control signals that direct one or more of the automation systems to perform the necessary steps to carry out the computerized system's instructions.

The flow-cell based biological detection system may also comprise a fluid handling station for introducing reagents and/or samples that may include gases and liquids. FIG. 1a depicts fluid handling station 471 that comprises flow control valves 470, reagent/gas detectors 500 and a fluid handling manifold 425. These devices may be independent fixtures fluidically connected (e.g., through flexible tubing) or may be integrated into a single system (as indicated by the dashed line). In an alternative embodiment, the location of valves 470 and sensors 500 along the fluidic lines is switched so that sensors 500 are between reagent bottles 472 and valves 470. The fluid handling manifold preferably includes an aspiration chamber employing a face-sealing configuration, e.g., using an o-ring 415 arranged on a sealing surface of the manifold, that is adapted to achieve a fluidic seal between the manifold and a sealing surface 410 of the pipettor (e.g., a collar, flange, or the like). As depicted, the fluid handling manifold sealing surface is preferably located away from the reagent input lines (e.g., above the reagent lines' aspiration chamber entry points). Additionally, one or more of the reagent entry points can be positioned at predetermined heights within the aspiration chamber; e.g., as depicted, the liquid reagent lines can be positioned beneath the gas reagent lines to preclude contamination of the gas lines. Reagent aspiration is preferably controlled by coordinating the selective actuation of one or more of the reagent valves 470 with the proper positioning of the pipettor and activation of the pump 870 so as to draw the reagents from the selected reagent bottles 472. Reagent detectors 500 can be employed to determine the presence and/or absence of reagent (e.g., whether one or more of reagent bottles 472 are empty), determine the presence and/or absence of gaseous reagents (e.g., when air is used to segment fluids as they are aspirated), determine/confirm the aspirated volume of a particular reagent, etc.

The biological detection system should be capable of precisely and accurately positioning the pipettor and the sample carrier so that the pipettor can be directed to aspirate/dispense fluids from a sample carrier and/or fluid handling station. Proper positioning can be accomplished through the use of alignment fixtures and/or through the proper training of the motion control system 102. To these ends, the system depicted in FIG. 1a utilizes positioning blocks 130, 140 arranged and configured to receive the sample carrier (here depicted as a microtiter plate) on a plate loader 110 and to apply biasing forces to the sample carrier to precisely position the sample carrier 115 to the predetermined position within the system. The predetermined position can be prescribed through the use of positioning stops. FIG. 1a illustrates preferred positioning stops 120 arranged on the plate loader as a rim partially defining a perimeter of a horizontal seating surface of the plate loader, however, any mechanical stop can be used. The positioning blocks 130, 140 ate preferably adapted and configured to precisely align the sample carrier 115 as it is being moved into the system by the plate loader 110. Additionally, as indicated in FIG. 1a, positioning blocks 130, 140 could also be configured to vertically retain/restrain the plate in the predetermined position, e.g., to prevent dislodgement of a sample carrier as a result of vertical forces such as the frictional forces experienced when 20′ the pipettor is withdrawn from a pierced seal on the sample carrier.

The biological detection system is, preferably, capable of determining if the sample carrier is present and properly positioned. Confirmation of the presence of sample carrier 115 and/or its proper positioning is achieved by interrogating the detector 200 depicted schematically in FIG. 1a. Preferably, the detector utilizes a mechanical arrangement of a single sensor and one or more floating lever arms that are each configured to sense a plurality of points on the sample carrier. Detection of a plurality of points on the sample carrier is preferable since, in general, the greater number of detected points, the greater the confidence level that the sample carrier is in the proper predetermined position. Furthermore, detecting a plurality of points on the sample carrier utilizing the least number of sensors is preferred for a multitude of reasons, including: reduced cost, complexity, reliability, maintenance, etc.

The motion control system is, preferably, trained or calibrated so as to compensate for manufacturing and/or assembly tolerances. In a particularly preferred embodiment of the biological detection system of FIG. 1a, the fluid handling manifold's aspiration chamber includes an aspiration chamber access port that is specially adapted to also serve as an alignment feature 455 for training the motion control system (discussed in detail below).

FIG. 1a also illustrates certain features that are designed to increase the overall maintainability of the biological detection system and/or its components. Specifically, positive displacement pump 870 is preferably configured with a pump head manifold 805 that is adapted to include a cleanout fluid path and plug 1158. Incorporation of the cleanout path and plug allows the pump's chamber (indicated by dashed lines) to be decontaminated in the event of failure of the pump's piston. Further modifications to the pump head manifold preferably include a bypass valve 970 that fluidically connects the input and output of the pump chamber and allows for manual back flushing of the system in the event of a clog.

The system depicted in FIG. 1a also depicts pump head manifold 805 having a modified pump chamber 806 that includes a gas trap 815, a sediment trap 820 and a passive/virtual valve (comprised of appropriately sized gas and sediment fluid exit passages; not labeled) for evacuating the pump chamber 806 of any residual gas bubbles and/or sediment that may result from normal use of the biological detection system.

In operation, plate loader 110 loads sample carrier 115 (e.g., a microtiter plate) and properly aligns it within the biological detection system through the use of positioning blocks 130 and 140 and positioning stop 120. Detector 200 determines if the plate is correctly positioned. Pipettor 405, under the control of motion control system 102, is positioned in fluid handling manifold 425 and/or a well of sample carrier 115 so as to aspirate samples and/or reagents and introduce them into flow cell 192 (the movement of fluids being controlled through pump 870, the selection of reagents aspirated from fluid handling manifold 425 being controlled by valves 470 and sensors 500 operating so as to send an error message if a reagent line becomes empty). Optionally, pipettor 405 may also be used to combine samples and/or reagents into an incubation chamber (e.g., to carry out assay reactions prior to introduction of samples into flow cell 192). The incubation chamber may be, e.g., a well of sample carrier 115 or an additional system component.

Assay measurements are conducted on samples and/or assay reaction mixtures in flow cell 192. Computer system 101 receives data and, preferably, carries out data analysis. After completion of a measurement, the flow cell is preferably cleaned and prepared for the next measurement. The cleaning process may include the introduction of cleaning reagents into flow cell 192 by directing pipettor 405 and pump 870 to aspirate cleaning reagents from fluid handling manifold 425 or sample carrier 115.

Plate Alignment/Hold-Down Device

Biological testing can often require the testing of numerous samples, compounds, etc. Often times, it is also preferred that such tests be conducted in a high-throughput or, at a minimum, in a very accurate, precise, efficient and low cost manner. Such requirements often lead to the use of high density microtiter plates as well as automation systems/subsystems. One such system provides for the automated loading/handling of microtiter plates. Microtiter plates are commercially available in various standardized sizes and formats (e.g., microtiter plates can have several different flange systems forming the base of the plate). The recognized specifying agency for microtiter plates, the Society for Biomolecular Screening (SBS), has defined three “standard” flange heights of 0.0948″, 0.2402″ and 0.3000″. Therefore, in order to achieve maximum flexibility and usability and to minimize human intervention, it is preferable for a system that handles microtiter plates (e.g., a biological detection system, plate reader, plate washer, fluid dispenser, etc.) to utilize automation equipment that is adapted and configured to handle more than one standard type of microtiter plate. For example, it would be particularly advantageous for two, or more preferably, each of the three standard plate heights defined by the SBS to be accommodated.

In addition to accommodating more than one type of microtiter plate, a plate holder is' also preferably configured to hold the plate so that it is not dislodged from its correct position during plate analysis or manipulation. In one embodiment, a plate handling system aspirates, or dispenses, fluid from, or to, a sealed plate (sealed with, e.g., septa or with a plastic or foil seal) using a needle probe to pierce the plate seal. The system will, preferably, comprise a plate holder that will hold the plate down during extraction of the needle and prevent the frictional forces from moving or dislodging the plate.

While it is important that the plate be properly retained, it is also preferable for the plate to be easily and accurately positioned within the plate handling system without being subjected to undue interference from the plate hold-down mechanism. Preferably, the two requirements of aligning the plate and retaining the plate can be performed by an appropriately arranged and configured device. Specifically, the plate positioning device would position the microtiter plate by, e.g., positioning the plate against mechanical stops arranged along the x and y axes, when the microtiter plate is drawn into the alignment and hold down device. Therefore, in preferred embodiments, the alignment and hold down device accommodates imprecise operator loading of a microtiter plate into, e.g., a loading tray of the reader, but yet ensures that the microtiter plate is precisely positioned for use by the plate handling system (e.g., a biological detection system, plate reader, plate washer, fluid dispenser, etc.). It should be noted that the plate hold down device of the invention is suitable for plate readers that conduct measurements directly on sample within a plate (e.g., plate luminometers, fluorometers, absorbance readers, etc.) and are also suitable for plate readers that aspirate sample from the wells of a plate for analysis in a separate component, such as a flow cell.

In accordance with particularly preferred embodiments, a plate handling system adapted and configured to employ one or more automation systems/subsystems, e.g., an automated plate loader, includes a simple alignment and retention device. A simple device would preferably employ mechanical means to accomplish plate alignment and retention so as to keep the system's electronics as simple as possible. FIG. 1b (oblique view) and 1c (stylized cross-sectional view) depict one preferred embodiment wherein a plate handling system operates in conjunction with an automated plate loading mechanism. In the following discussion, unless otherwise indicated, the plate loader 110 moves along the y-axis on the baseplate 105.

A simple, mechanical device for aligning and retaining a plate within a plate handling system, in accordance with one embodiment, would preferably employ two positioning blocks 140, 130 positioned in opposing relation to one another and spaced apart such that a microtiter plate 115 may be loaded into the reader using an automated plate loader 110. The positioning blocks 140, 130 can be arranged and configured to receive/engage either the short sides or the long sides of the plate. It should be noted that while the associated figures herein depict the positioning blocks as receiving the short sides of the plate, the accompanying discussion may also pertain to an alternative configuration wherein the long sides of the plate are received/engaged.

As previously discussed, a preferred biological detection system will be capable of processing more than one standard sized microtiter plate. In one preferred embodiment, the positioning blocks 140, 130 would include arms 142, 144 that are operable to apply a biasing force to a plate 115 as it is being positioned in the reader by an automated loading mechanism 110. The biasing force is applied, e.g., by spring loading the arms with conventional springs such as mechanical springs (e.g. compression springs, spring coils, flat springs, washer springs, leaf springs, etc.), hydraulic springs, pneumatic springs, elastic materials and the like. The biasing force applied by the arms would preferably be sufficient to accurately position the plate within the reader. Such positioning could, e.g., be accomplished by providing mechanical-stops along both the x and y axes. The plate would therefore be accurately and repeatably positioned at a predetermined location in the reader as the plate is moved under the influence of the biasing force applied by the arms, ultimately coming to rest against the plate position stops. Positioning arms, such as arms 142 and 144, preferably have a plate contact surface that is beveled or curved so as to allow the arms to increasingly engage the plate as the plate is moved into position and to allow for manufacturing tolerances.

FIG. 1i shows a detailed top view of specific preferred embodiments of positioning blocks 130 and 140. Block 195 comprises positioning arm 196 with a beveled plate contacting surface 197. The arm is configured to apply a biasing force through the use of compression springs 198 arranged between arm 196 and block housing 199.

According to one embodiment, positioning block 140 includes two positioning arms 142, 144 whereas opposing block 130 includes one positioning arm 132. One of the positioning blocks would be configured as the dominant block while the other would be configured as a subordinate block; e.g., the positioning block having the larger biasing force arms would be the dominant block and the positioning block having the lesser biasing force arms would be the subordinate block. Therefore, in one embodiment, dominant positioning block 140 would have dominant arms 142, 144 that are adapted to exert a larger biasing force upon'the microtiter plate 115 as it is drawn into the system than the subordinate arm(s) 132 of subordinate positioning block 130; e.g., by utilizing stronger springs in block 140 and weaker springs in the opposing block 130.

Accordingly, as the plate 115 is being drawn into the plate handling system by the plate loader 110, the larger force exerted on the plate by the more powerful arms 142, 144 will cooperate with the less powerful arm(s) 132 to bias, or slide, the plate in the x direction until it comes to rest against the x axis stop(s). In accordance with another aspect of the invention, the drag created by the biasing arms 142, 144 and 132 acting cooperatively upon the sides of the microtiter plate bias/slide the plate until it comes to rest against the y-axis stop(s). Thus, the plate can be precisely positioned within the reader according to the predetermined stop positions/locations; e.g., if the stops are physically located on the plate loader itself (e.g., plate stop 120 shown in FIG. 1a which is, preferably, provided by at least a partial rim on plate loader 110), halting travel of the plate loader in a consistent position would produce a precisely positioned plate in both the x and y axes.

Additionally, the vertical arrangement of the positioning arms would be selected in accordance with the different standard sized plates that may be processed by the system as illustrated by FIGS. 1e-1g.

The plate holding mechanism, preferably, prevents an upward vertical force from dislodging the plate. Advantageously, the arrangement and configuration of the positioning arms serves the purpose of retaining/restraining the plate along the vertical direction (z-axis). For example, in accordance with one preferred embodiment, FIG. 1d depicts a plate alignment and retention apparatus capable of retaining the plate in the aligned position while being subjected to the extraction force of a probe as it is retracted through a seal covering a well.

The z-axis positioning/retention is accomplished by appropriately arranging and configuring the plate positioning arms. Preferably, as the plate 115 is drawn into the system by the plate loader 110, the positioning arms 142 and 144 would be adapted and configured to retract when the flange engages and advances beyond at least a first end of one or more of the arms (e.g., the plate slides along a beveled or curved surface of the arm so as to increasingly engage the arm as the plate advances). Accordingly, the arms that are not contacted by the flange of the plate as it is drawn into the system are not retracted but instead serve as a ledge surface to provide a mechanical stop along the z axis. Alternatively, the top-most arm contacting the flange can comprise a step surface that provides a ledge to provide a mechanical stop along the x-axis. By way of example, positioning arms 144, 142, and 132, as shown in FIG. 1c, have step surfaces for providing mechanical stops in the z-direction (see, e.g., ledge surface 149 in FIG. 1c provided by a step in arm 144). Therefore, the plate flange would preferably be positioned, i.e., come to rest, under a positioning arm or positioning arm step, thus securing the plate from motion in the z direction. As previously discussed, to accommodate multiple flange heights, the positioning blocks would preferably include multiple retractable positioning arms; e.g., 142, 144 and 132.

Alternatively, according to another preferred embodiment shown in FIG. 1h, the positioning block could be adapted and configured to employ a single positioning arm having multiple steps or ledges. Such an approach is most advantageously used in conjunction with the subordinate block so as to reduce the number of arms on the subordinate block (i.e., each ledge on a multi-stepped arm can be used to provide a vertical stop for a different flange height).

According to a most preferred embodiment, part of the positioning blocks 130, 140 can be adapted and configured to provide a stop along the z-axis to serve as the retainer ledge 131, 141 for the tallest flanges. Advantageously, such a preferred embodiment enables the positioning blocks 130, 140 to have a simpler configuration, i.e., fewer number of positioning arms, since the positioning arms would only have to retain, the lower height flange systems of standardized plates; e.g., in a preferred system configured to process three different microtiter plates, the positioning arms would only have to retain (in the z-direction) the medium and low height flanges. For example, where three different plate flange heights must be accommodated, positioning block 130 can comprise a single positioning arm having a step that is arranged and configured to slide over the short flange plate, capture the medium flange plate through the positioning arm's step and completely move out of the way and allow the tall flange plate to be vertically restrained by the fixed stop 131 of the positioning block.

FIG. 1c depicts one embodiment wherein the dominant positioning block 140 comprises two separate and individually operable positioning arms 142 and 144. Preferably, the upper arm 142 would retract when engaged with standardized plates having the tallest flanges and the lower arm 144 would retract when engaged with all standardized plate heights. In operation, the plate loader 110 would preferably draw the plate 115 between the two positioning blocks 140 and 130. As the appropriate positioning arms are engaged by the translating plate, the high force and low force biasing means operating on the positioning arms would cooperate to guide the plate into the predetermined/predefined position within the reader; i.e., the plate would come to rest against the stops provided along both the x and y axes of the reader. Accordingly, the plate is properly positioned along the z-axis, or restrained from lifting, by the corresponding z-axis stops of the positioning blocks 140 and 130 in FIG. 1c; i.e., the plate is properly positioned along the z-axis by the corresponding positioning arms and/or the fixed stops of the positioning blocks that protrude above the flanges of the plate 115.

FIG. 1d illustrates the operation of one embodiment utilizing the preferred z-positioning/retention device/method described above (for simplicity of illustration, only a portion of the plate and one positioning block is depicted). Preferably, in operation, a plate 115 having a seal 155 would be pierced by a probe 150 when the probe 150 is moved into the well 152 through a downward motion of the probe 150. In particularly preferred embodiments, there would exist a gap between the protruding flanges 142, 144, 141 and a flange 160 of the plate 115. Such a gap advantageously accommodates any molding variations (e.g., manufacturing tolerances prescribed by the SBS plate standard) that might normally exist in the plate as a result of the prescribed manufacturing process. As illustrated in FIG. 1d, as the probe 150 is extracted from the well 152 to which it has gained access by piercing the seal 155, it tends to lift the plate 115 due to the frictional force which may develop between the seal and itself (illustrated by the raised edge of the seal 156). In this preferred embodiment, the plate 115 is prevented from rising out of the positioning apparatus since the plate flange 160 comes into contact with the corresponding ledge of the plate positioning arm 142, 144 or the positioning block.

Using the preferred devices and method, multiple plate sizes can be similarly accommodated. FIGS. 1e-1g depict one embodiment wherein the positioning blocks are adapted and configured to receive microtiter plates manufactured in accordance with three different SBS specifications. FIG. 1e depicts a SBS “short flange” plate in the plate holder. As depicted, and in accordance with the discussion above, the short flange 160 of plate 115 would preferably be captured vertically by the flange on the lower positioning arm 144. In this example, at least the lower positioning arm 142 would preferably provide horizontal pressure, or x-axis biasing, on the plate 115 to properly position the plate within the reader (as depicted, both of the positioning arms 142, 144 provide x-axis biasing). The flange of the “short flange” plate is completely under arm 132 of subordinate block 130 so that the bottom of arm 132 provides a ledge surface that constrains the plate in the z-direction. FIG. 1f depicts a SBS “medium flange” plate in the plate holder. In this instance, the plate 115 would be captured vertically by the upper arm 142 while both upper arm 142 and lower arm 144 could provide the horizontal pressure. The flange of the “medium flange” plate engages arm 132 of subordinate block 130 and is constrained in the z-direction by a ledge provided by a step in the plate contact surface of the arm. FIG. 1g illustrates a SBS “tall flange” plate 115 in the plate holder. It can be seen here that the plate 115 is captured vertically by the fixed stop 141 of the positioning block 140 and the fixed stop 131 of positioning block 130 and that both the lower and upper positioning arms 142, 144 are providing horizontal pressure.

Plate Detection/Alignment Sensor

Preferably, assay systems that handle or manipulate containers for carrying samples and/or reagents (referred to herein as sample “carriers”) are capable of determining if a plate is seated properly within the system. Improper insertion can lead to misidentification of sample compartments (e.g., wells in a multi-well plate), spurious results and/or instrument failure. Thus, assurance that the carrier is inserted correctly is of paramount importance. Correct alignment of multi-well plates in assay systems that handle or manipulate multi-well plates (e.g., plate readers, plate washers, fluid dispensing systems, plate movers, etc.) is especially important in order to ensure that the systems interrogate the correct wells of the plates. Certain preferred biological detection systems employ a movable plate, loader for receiving, retaining and/or aligning a sample carrier such as a multi-well plate and for drawing that carrier into the reader for processing. In accordance with a preferred embodiment, increased reliability is made possible through use of stationary detection means; e.g., the detection means are located on stationary parts as opposed to moving parts. Stationary detection means are advantageous in that their usage preferably precludes the need for moving electrical connections, which are historically unreliable and prone to failure; e.g., mechanical failures associated with fatigue, and the like.

The determination of whether a carrier is properly positioned, preferably, involves detecting the location of multiple points on the carrier, e.g., two points on the edge of a multi-well plate. Detecting the location of a single point is not sufficient to unambiguously determine the position of the carrier (e.g., to account for both correct translation and yaw). By way of example, a small undesired rotation of a plate around the vertical axis may not be detected with a single point measurement. Multi-point measurements are usually accomplished by the use of multiple position sensors positioned about the carrier receptacle. This would normally require, e.g., that each of the sensors be interrogated and their signals considered/scrutinized in order for the proper positioning of the carrier to be verified; e.g., the carrier is properly positioned when each of the sensors is tripped. Moreover, accurate sensing of position using multiple sensors would normally require that each of the sensors be accurately positioned. If particularly precise positioning of the sensors is required then individual adjustment of the sensors may be required.

It is therefore preferable to detect multiple locations through the use of a single appropriately adapted/configured sensor. A single sensor would-be less costly and simpler since, e.g., the use of a single sensor would require that only one sensor be accurately positioned whereas use of multiple sensors to detect multiple positions would require that each of the multiple sensors be accurately positioned.

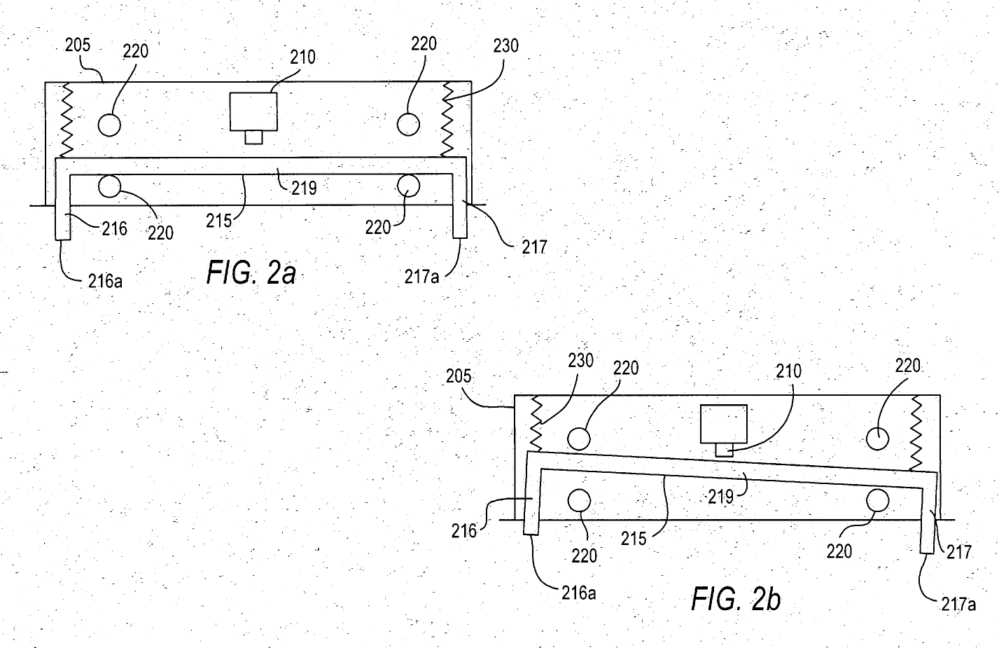

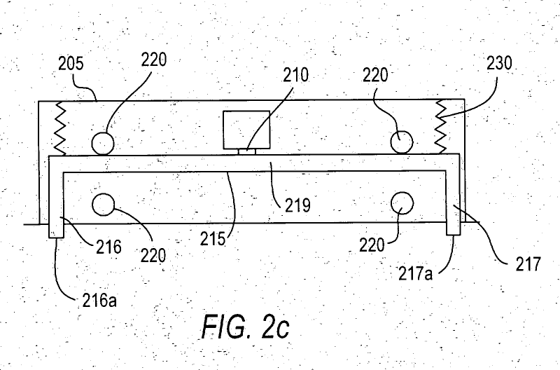

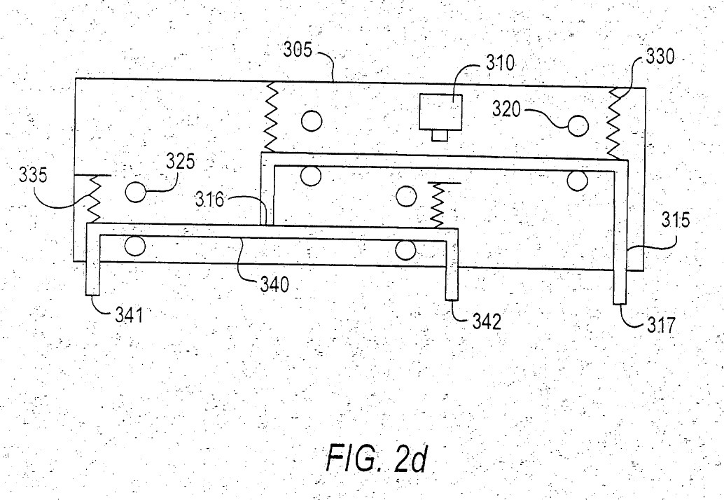

Accordingly, the detection of multiple points on the carrier is preferably accomplished using fewer sensors than the number of points to be sensed. FIGS. 2a-2d depict preferred embodiments wherein a floating lever, or levers, can be used for detecting multiple points on the carrier with only a single sensor. The floating lever or levers are designed such that multiple actuation points on the lever, or levers, must be actuated in order for the sensor to be tripped. In accordance with preferred embodiments, the mechanical arrangement and/or linkage of the lever(s) is configured and arranged to detect multiple points on a single line, on a single plane or on multiple lines or planes.

FIG. 2a illustrates one preferred embodiment that uses two points of contact to determine the correct alignment of a sample carrier. This embodiment comprises a floating lever 215 with two lever ends 216 and 217 and a sensor 210 positioned to detect the position of sensing point 219 on lever 215 that is located, preferably, between lever ends 216 and 217. The lever 215 is adapted and configured to be a floating lever through appropriate geometrical configuration and mechanical arrangement/linkage; i.e., each end of the lever can preferably pivot relative to the opposite end. The sensor is positioned, in accordance with one embodiment, such that it is necessary for both ends of the lever to be contacted/engaged and moved/actutated to predetermined positions in order that the sensor be tripped. These predetermined positions are preferably arranged to indicate, or coincide with, the carrier's correct placement within the system and to result in the sensor being tripped.

In particularly preferred embodiments, false indications of proper placement/positioning/seating of the carrier can be substantially eliminated or reduced through the provision of properly placed rotation stops 220. Inclusion of appropriately placed rotation stops 220 prevents possible over rotation/actuation of one lever end leading to the sensor being tripped inappropriately, or prematurely; i.e., actuation of only one end, or insufficient actuation of both ends, preferably does not result in the sensor being tripped. Stops 220 also act to hold lever 215 in place. As shown in FIG. 2a, stops 220 may be physical barriers placed to the sides of the lever (e.g., one stop adjacent-to each lever end on the sensor side of the lever and/or one stop adjacent to each lever end on the plate side Of the lever). In an alternative embodiment, the rotation stops are provided by a pin/slot configuration using slots cut into the lever, preferably one slot on, each lever end; a fixed pin slides within the slot(s) on the floating lever, the dimensions of the slot(s) defining the limits of the lever's motion.

FIG. 2b illustrates an operational condition in which only one lever end 216 is contacted and moved. Accordingly, proper arrangement and configuration of the floating lever 215 and the sensor 210 preclude this condition from being one in which the sensor 210 is actuated; i.e., sensing point 219 is not translated a sufficient distance to actuate sensor 210. Thus, verification of the carrier being properly positioned would not result from this condition even though one point on the plate may be properly located. FIG. 2c illustrates another operational condition in which both lever ends 216, 217 are contacted and moved. Under this condition, sensing point 219 is translated a sufficient distance to actuate sensor 210. Here, such a condition would provide verification that the carrier has been properly placed/positioned within the system since movement of both ends 216, 217 of the lever 215 to their respective predetermined positions results in the actuation of the sensor 210; i.e., the two points on the carrier to be interrogated for proper positioning are in the predetermined positions for proper positioning/placement.

It should be noted that while FIGS. 2a-2d illustrate floating lever(s) with lever projections (i.e., fingers, protrusions or extensions at each end of the lever that make contact with the carrier, e.g., lever projections 216a and 217a), these projections need not necessarily be part of the lever. Specifically, the floating lever can be modified such that it does not include any lever projections and instead, the carrier itself has included thereon appropriately placed and sized projections, e.g., fingers, protrusions, extensions, or the like, for contacting the lever. Alternatively, no projections are included and the lever provides a surface that conforms to a surface of the carrier and provides for multi-point contact with the carrier.

The floating lever 215 may be enclosed in a housing 205 with adequate spring biasing 230 of the lever 215 to prevent inappropriate tripping of the sensor 210. The spring biasing may be provided by one or more compression springs, preferably, arranged between the housing and lever 215 as depicted in FIGS. 2a-2d. Alternatively, any biasing means capable of returning the lever 215 to its not actuated position may be used. Biasing means may be provided by conventional springs, e.g., mechanical springs (compression springs, flat springs, torsion springs, spring coils, washer springs, leaf springs, etc.), hydraulic springs, pneumatic springs, elastic materials and the like. Biasing may also be provided by mechanical actuators such as electromagnetic actuators, pneumatic actuators, hydraulic actuators and the like. The sensor may be any conventional sensor for detecting the position of lever 215, e.g., a non-contact sensor such as an optical sensor (e.g., a photo-electric sensor), magnetic sensor (e.g., a Hall Effect sensor) or capacitive sensor or a contact sensor such as a mechanical switch. An especially preferred sensor is a limit switch. Suitable switches include single pole, double throw switches; single pole and single throw switches. The sensor could, optionally, be variably/adjustably mounted so as to allow the sensor to be positionally adjusted.

As already discussed above, lever 215 is, preferably, retained/constrained by mechanical stops 220 to prevent the lever arm 215 from either falling out or being over rotated. Preferably, mechanical stops 220, are arranged to restrict the displacement of lever ends 216 and 217 between lever end minimums (e.g., the normal position of the lever ends as determined by the biasing forces in the absence of carrier) and/or lever end maximums (e.g., a displacement equal to or greater than the maximum expected displacement in the presence of an appropriately positioned carrier). In one embodiment of the invention, one or more of mechanical stops 220 are omitted and mechanical stops are, alternatively, provided by housing 205.

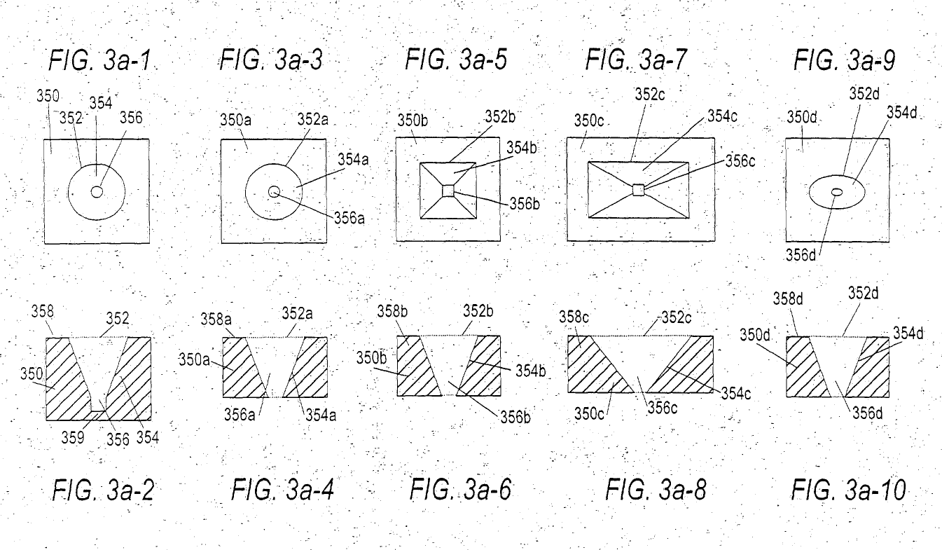

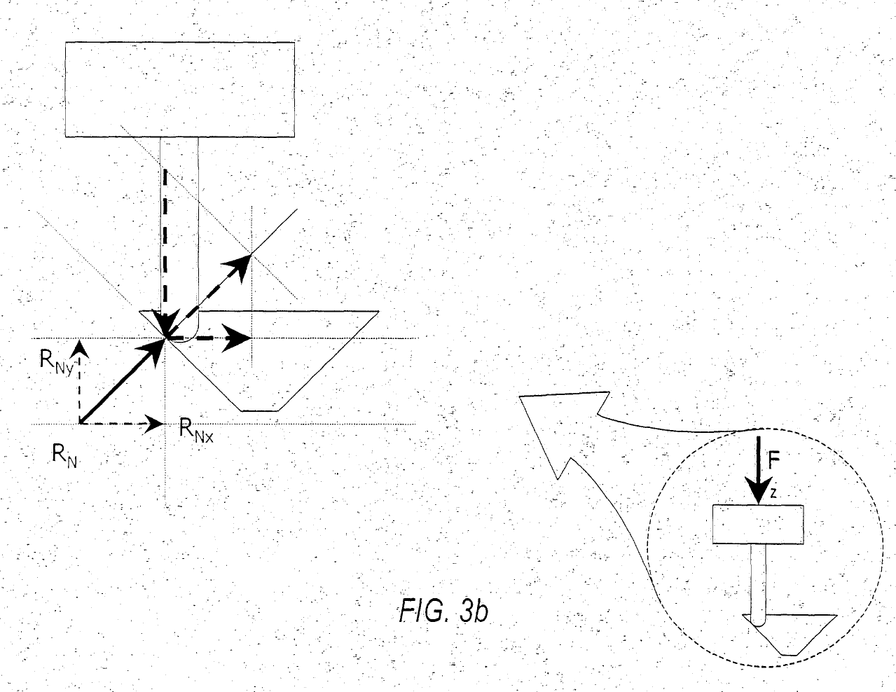

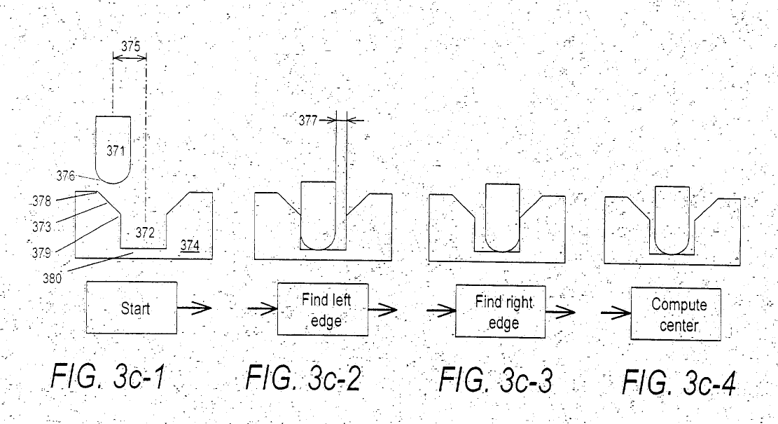

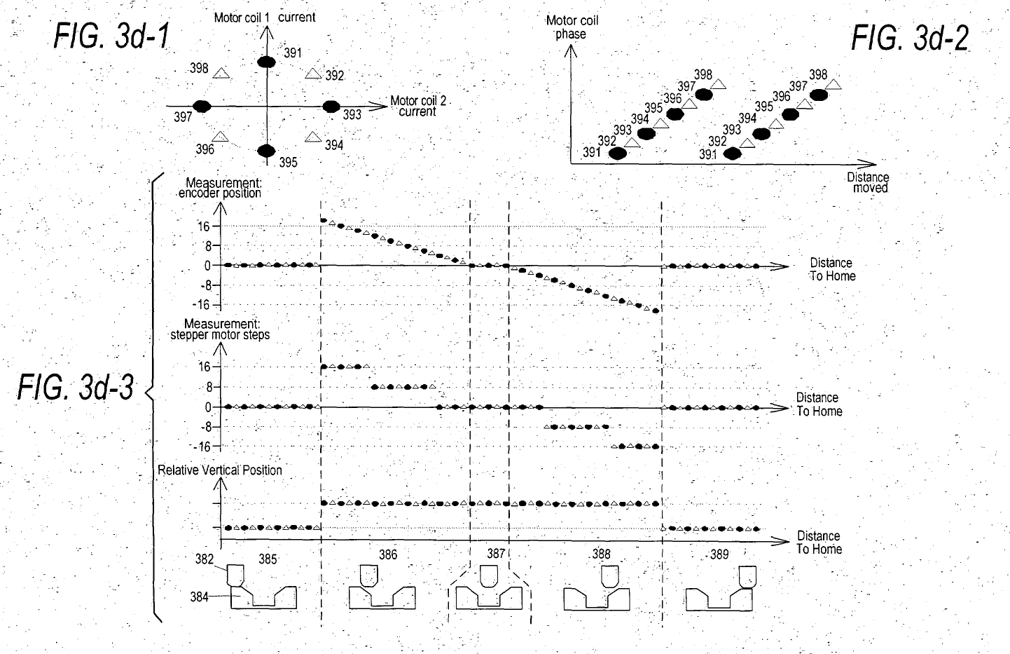

In yet another preferred embodiment, a multi-lever configuration may be employed. In one embodiment, as shown in FIG. 2d, lever 340 has two projections 341 and 342, these two lever projections 341, 342 function essentially as discussed above, however, their actuation alone cannot directly trip the sensor 310. Together, projections 341 and 342 must be acted upon, or actuated, to move projection 316 of lever 315 to the correct location; i.e., the predetermined position for projection 316. In conjunction with projection 316, projection 317 of lever 315 must also be moved/actuated to the correct position, or predetermined location, in order to trigger the sensor. Thus, in the preferred configuration shown in FIG. 3, three points, corresponding to projections 341,-342 and 317, must all be simultaneously contacted and moved, i.e., actuated, to their predetermined “triggering” positions in order to trigger the sensor 310. In such a preferred embodiment, no combination of-less than all three lever ends 341, 342, and 317 will trigger the sensor 310. This cascading of levers can be extended to include as many contact points as desired. In addition to possessing the added advantage of interrogating even more additional points on the carrier as there are sensors, a still further advantage of the multi-lever system is that the contact points need not be co-planar. For example, lever 317 may project more or less out of the housing than projections 341 and 342. Projection 317 may also be positioned vertically offset (the dimension not shown in FIG. 3; i.e., into/out of the page) from projections 341 and 342.

Clearly then, use of a properly arranged and configured floating lever, or a multiplicity of floating levers, can result in the reduction of the number of sensors required for positional verification of the carrier, the reduction of the extent and number of adjustments needed in the detection system to ensure accurate and precise operation and the reduction of the number of sensor signals that must be processed to verify correct carrier positioning.

Motion Control Training/Alignment

Fluidic based biological detection systems may employ a fluidic probe (e.g., a pipettor, syringe needle, etc.) to aspirate or dispense samples and reagents from, e.g., sample carriers such as microtiter plates, cartridges/cassettes, test tubes, vacuutainers, and the like. In systems that use automation systems to control the movement and position of the probe, it is important that the probe position is accurately and precisely controlled so as to ensure that the correct materials are aspirated from or dispensed to the correct sample carrier and/or sample carrier well.

By way of example, FIG. 1a shows a flow cell based assay system that includes a probe 150 for aspirating samples and reagents from microtiter plate 115 and/or fluid handling manifold 425. Probe 150 is moved using a motion control system that controls a z-axis actuator 177 that moves the probe in the direction perpendicular to the plate and one or more actuators that move the probe along one or more paths parallel to the plate. These paths can be any arbitrary shape but are preferably linear or radial; FIG. 1a shows two linear actuators for moving the probe along paths parallel to the plate, an x-axis actuator 176 and a y-axis actuator 175. Linear actuators are, preferably, driven by motors such as DC motors or stepper motors and are, more preferably, based on motor driven ball screw, acme screw or belt drive assemblies, and are most preferably driven by stepper motors. Optionally, the motion control system may include one or more sensors (e.g., position sensors, contact sensors, encoders such as optical encoders, pressure sensors, limit switches, etc.) that report the position of the probe along one or more degrees of freedom or detect when the probe hits a defined position or reaches the limit of travel along one or more degrees of freedom.

The motion control system should be capable of controlling the position of probe 150 sufficiently accurately and precisely to ensure that the probe can aspirate fluids from the correct location. Errors in position could lead to misidentification of samples or cause damage to the probe. Manufacturing tolerances may not be sufficiently precise to ensure that the system, as manufactured, can position the probe with the required accuracy. It may, therefore, be necessary to calibrate the motion control system so as to compensate for dimensional variations that may have occurred during assembly.

In preferred embodiments, motion control systems (MCS) are operated in a manner such that the motion of a specific component, e.g., a fluidic probe, is referenced to an origin; e.g., the home position (for clarity, a fluidic probe shall be used throughout the remainder of the discussion; however, it is to be understood that the MCS can be used to move any one of a number of other components, e.g., sample delivery carrier, sensors, etc.). The home position is, preferably, determined by instructing the motors making up the MCS to travel in a given direction until no further travel is possible; i.e., the motor is “homed.” By locating the home position at the limit of the travel, there is no ambiguity in which direction to proceed to reach the home sensors. Preferably, the end of travel or home location in a motion control system may be determined by, e.g., i) a mechanical stop at the end of travel coupled with a position sensor such as an optical encoder that allows the relative motion of the motion control system to be monitored and that can signal when the probe has reached the end of travel and stopped moving; ii) a limit switch that is triggered when the motion control system reaches the limit of travel along a particular direction or degree of freedom or iii) a mechanical stop coupled with a feedback system within a motor controller that signals when the motor experiences an increase in resistance to motion, e.g., via measuring an increase in motor current when the hard stop is reached; and iv) driving the motion control system to a mechanical stop at the end of travel of one or more axis and allowing the drive motor to stall at the end of travel.

By referencing the position of the MCS to a home position, calibration of the MCS can, preferably, be accomplished by training the MCS; e.g., ascertaining/determining the distance from the home position to one or more relevant features within the system. The term relevant features is used here to refer to locations where the MCS must be capable of moving the probe; e.g., locations within the biological detection system where samples, reagents, coreactants, etc. are acquired or locations that allow the probe to be serviced or shipped without damage. In a particularly preferred embodiment, a training or locating technique is employed that uses an appropriately designed mechanical configuration and a method of operation employing a refinement algorithm.

In accordance with a preferred embodiment, an appropriate mechanical configuration would include an alignment feature that is sized and configured according to the known part and assembly tolerances. The position of the alignment feature relative;

to one or more other relevant features of the system is preferably known to a high degree of precision. FIGS. 3a-1, 3a-2, . . . , 3a-10 show top views and cross-sectional views of several preferred geometries for alignment features. Preferably, alignment feature 350 (350a-d) has a first opening 352 (352a-d) that is sized large enough to account for the known tolerances in probe position and also has one or more tapered walls 354 (354a-d) forming a contact surface/guiding surface and, preferably, extending from the first opening to a second opening 356 (356a-d) sized to precisely receive the probe; e.g., an inverted truncated cone, an inverted truncated pyramid, or the like. Preferably, the size of the second opening is sufficiently small and defines the position of the probe with sufficient accuracy (most preferably, in relation to the home position) so that the probe can be accurately moved to the required relevant features of the system. Optionally, the alignment feature also includes a vertical stop (preferably defined by a surface at the top—e.g., surface 358 (358a-d)—or bottom—e.g., surface 359 (359a-d)—of alignment feature 350 (350a-d)) that defines the maximum travel of the probe through the alignment feature (e.g., the stop may be a surface that defines the bottom of the alignment feature that contacts the probe tip or a surface at the top of the alignment feature that contacts a collar or other ledge along the length of the probe). The vertical stop may be used to define the vertical position of the probe (e.g., through the use of a sensor, preferably coupled to the probe, such as a limit switch, proximity sensor, contact sensor or preferably a pressure sensor, that indicates when the probe has hit the vertical stop).

According to preferred embodiments, the tapered walls of the alignment feature are tapered such that the probe, under control of the MCS, enters the reference/alignment feature by striking/impinging upon the walls of the alignment feature at an angle. The angle is, preferably, selected such that the force applied in the axis by the MCS is resolved into component forces along the x and y-axes that are sufficiently large enough to move the probe in those respective directions while the force applied along the z-axis by the MCS is not large enough to stall the MCS or otherwise limit its travel (See FIG. 3b). Preferred wall angles are 10-60 degrees, more preferably 30-50 degrees from vertical. Advantageously, the actuator(s) controlling movement in the plane of the plate are turned off and/or disengaged during this alignment procedure so as to allow the probe to freely glide along this plane. Most preferably, the angle is selected such that the height (e.g., distance in the z direction) of the tapered walls approaches the minimum required to achieve the proper balancing of forces (as described above) so as not to make the depth of the alignment feature unnecessarily large.

FIGS. 3c-1, 3c-2, 3c-3 and 3c-4 illustrate a preferred process by which a MCS can be automatically calibrated (the figure shows the alignment of only one dimension along the x-y plane but can be extended by analogy to cover two dimensions). The MCS controls the position of a probe 371 (having, preferably, a rounded probe end 376) and directs it to the initial estimated position/expected location of the center 372 of alignment feature 374. Because of tolerance stack-up among the parts and variations in assembly, there is an error 375 in the initial estimate of the position of center 372. A first opening of alignment feature 374 defined by edges 378 is sized in accordance with the manufacturing tolerances and the dimensions of probe end 376 so that the probe can be directed into the opening, even when error 375 has the maximum value predicted by the manufacturing tolerances.

In a first alignment procedure, the probe is allowed to move freely in the horizontal direction (e.g., by disengaging and/or de-energizing the actuators in the x-y plane) while the probe is moved in the z direction. Disengagement may include a mechanical decoupling step, e.g., the release of a clutch and the like. Probe 371 can slide horizontally along the surface 373 and come to rest in a location (shown in FIG. 3c-2) that has a positional uncertainty 377 that is much less than error 375. Optionally, probe 371 is translated until it contacts a vertical stop, e.g., bottom 380 of alignment feature 374. The position of probe 371 as shown in FIG. 3c-2 can be measured relative to the home position via the use of positional sensors such as encoders. Alternatively, the probe can be directed from the position shown in FIG. 3c-2 to home and the distance of travel measured (e.g., by counting encoder increments, motor rotations, stepper motor steps, etc.) so as to determine the position of the alignment feature relative to home.

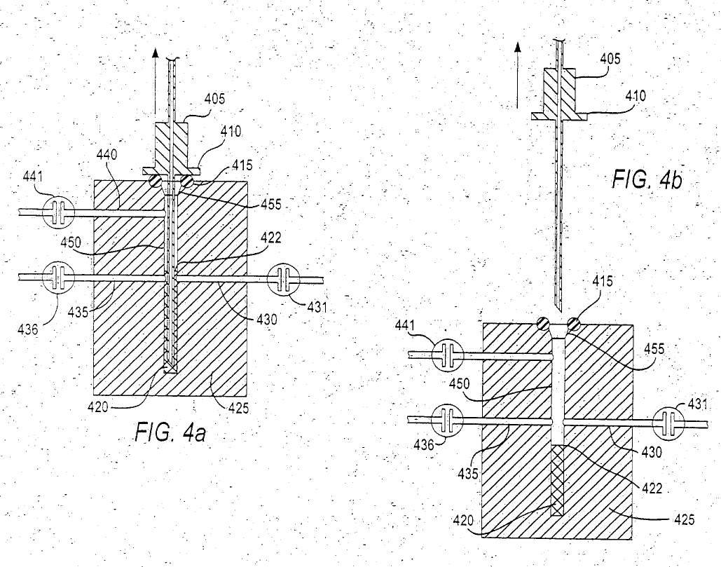

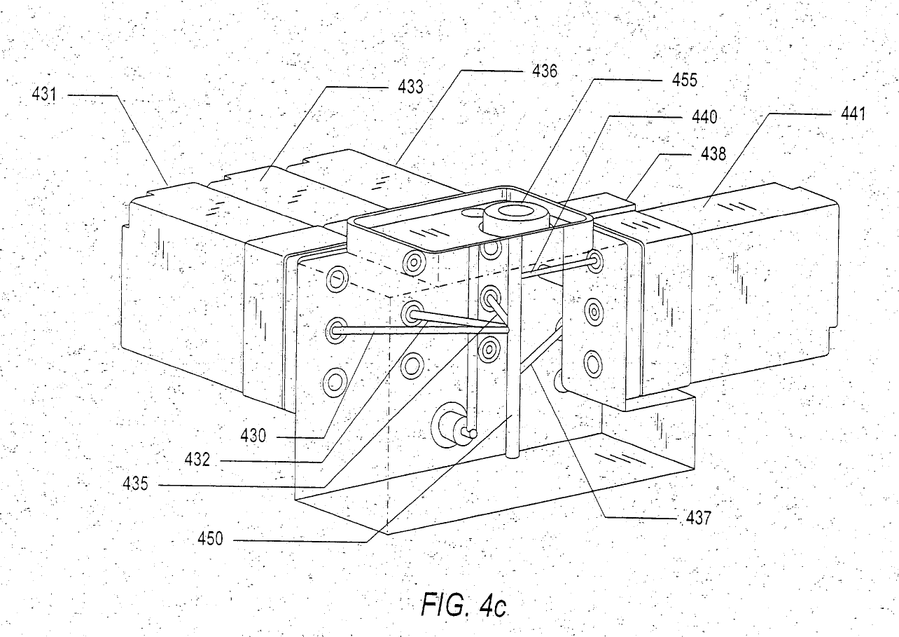

The position of probe 371 may be even more accurately located through an iterative refinement procedure. FIG. 3c-2 shows that probe 371 has slid into a location along one edge of a second opening defined by edges 379 and has a positional uncertainty 377. Optionally, the probe is raised and translated to the opposing side of the alignment feature and a second alignment procedure is conducted so as to situate the probe against the opposing edge of the second opening (as shown; in FIG. 3c-3). The location of the probe is determined and the location of the center of the alignment feature is calculated as the average of the location of the two edges (FIG. 3c-4). Alternatively, the iterative procedure could involve locating edges in multiple alignment features.

During the first alignment procedure, it is possible that the probe may passthrough the second opening without touching a side wall. Optionally, this first alignment procedure would be followed by i) raising and translating the probe a distance sufficient to ensure that it is above a tapered wall of the alignment feature; ii) conducting a second alignment procedure for locating; one edge of the second opening; iii) raising and translating the probe a distance sufficient to ensure that it is above a tapered wall on the opposing side of the alignment feature and iv) conducting a third alignment procedure for locating the opposing edge of the second opening.

The approach to locating and identifying edges of the alignment feature may vary depending on the nature of the instrumentation used in the motion control system. FIGS. 3d-1, 3d-2 and 3d-3 illustrates certain alternative approaches. In the simplest case, the motion control system includes position sensors such as encoders for monitoring the position of probe 382. FIG. 3d-3 (at top) shows the magnitude of horizontal motion that would be detected by a position sensor as a function of the initial probe position during an alignment procedure (i.e., the lowering of the probe into alignment feature 384 with the horizontal actuators disengaged). If the probe hits a tapered wall, (e.g., probes in regions 386 or 388), the horizontal translation along the wall will be registered as a change in encoder position. The direction of the translation will indicate by which edge of the second opening the probe is located (e.g., probes in regions 386 and 388 are translated in opposite directions) and the final encoder value will indicate the location of the edge. If the probe does not touch a tapered wall (e.g., probes in region 387 located within the region defined by the second opening), the probe will not move in a horizontal direction during the procedure. The probe may then be raised and translated a fraction of the width of the alignment feature to ensure that it hits a tapered wall. If the probe completely misses the alignment feature (probes in regions 385 or 389), there will also be no horizontal displacement; this error condition can be distinguished from a centered probe (e.g., probes in region 387) by the difference in vertical displacement (FIG. 3d-3 (at bottom)).

If the system does not include positional sensors, the position of the probe can be determined by measuring the distance of the probe from home (i.e., by sending the probe home and measuring the distance traveled, e.g., by measuring motor rotations, stepper motor steps, etc.). Horizontal translation of the probe during an alignment procedure will result in a change in the distance of the probe from home. Determining the location of alignment feature edges can be determined analogously to the method described above for systems having positional sensors.

In one embodiment of the invention, the probe is moved in a horizontal direction by a linear actuator that is driven by a stepper motor. The position of the probe after an alignment procedure is determined by measuring the stepper motor steps required to bring, the probe back to home. A stepper motor has a number of defined rotational positions (“half steps”). The motor can be driven to take any of these rotational positions by applying the appropriate electrical input. FIG. 3d-1 shows, for a stepper motor with eight defined positions 391-398, the motor position as a function of the electrical input (currents to motor coils 1 and 2). If the motor is in an undefined position and the input corresponding to position 394 is applied, the motor will turn until it reaches that position by turning in the direction that results in the least amount of rotation.

In a preferred alignment procedure according to this embodiment: i) the probe is directed to a position above the alignment feature; ii) the stepper motors driving horizontal actuators are de-energized so as to allow the motors to spin freely and the probe to glide freely in the horizontal plane; iii) the probe is lowered into the alignment feature; and iv) the probe is raised out of the alignment feature and the motors are re-energized. If a stepper motor for a horizontal actuator is in position 394 at the beginning of the procedure, any translation that occurs during the alignment procedure will rotate the motor to an undefined location. On re-energizing the motor, the motor will return to position 394 by turning in the direction that results in the least amount of rotation. Depending on the amount of translation, the actuator will, therefore, return to its original position or to a position that is one or more full rotations away (i.e., multiples of eight half steps for a motor with eight half steps per full rotation). The translation of the probe after this alignment procedure as a function of the initial position of the probe is illustrated in FIG. 3d-2. The center of the alignment feature may be found through an iterative process of conducting alignment procedures from different initial probe positions and measuring the final probe positions (e.g., by measuring the distance to home) until locating the maximum and minimum initial distances from home (within the dimensions of the alignment feature) that result in the actuator returning to its initial position. The center of the alignment feature is the average of these two initial positions. The number of steps in the iterative process may be reduced or minimized through the use of an appropriate refinement algorithm such as, e.g., a binary search algorithm or the like.

In certain preferred embodiments, the reference/alignment feature may offer the added functionality of being an access port through which a probe positioned by the MCS can aspirate liquid; e.g., samples, reagents, coreactants, etc.

In certain preferred embodiments, the probe employed for training the MCS may be the fluidic probe that is used during normal operation of the system. In other preferred embodiments, the probe may employ a sharp tip (e.g., when it is required that the probe pierce a membrane, stopper, or the like) and may be sub-optimal for performing the preferred alignment method in a non-destructive manner. In this case, the probe's mounting apparatus can be adapted and configured to receive a detachable/interchangeable probe. For the purposes of carrying out the probe training, a specially designed/configured blunt ended (e.g., flat or rounded) calibrating probe can be installed/attached for the alignment procedure and subsequently interchanged with an operational probe for normal operation of the system. Alternatively, instead of employing a separate calibration probe which must be interchanged with an operation probe to carry out the alignment process, another preferred embodiment could employ a probe in which the sharp probe tip is retracted into a sleeve with a rounded/blunt tip (e.g., similar to the manner in which a ball point pen is retracted into the pen body), or a sleeve with a rounded/blunt tip lowered over the sharp probe tip, or the like.

Improved Fluid Handling Station

Biological detection systems utilizing liquid consumables, such as reagents (e.g., buffers, coreactants, particulate solid phase supports for assay reaction, cleaning solutions, and the like) may be susceptible to evaporation of the liquid consumables that may alter their composition and therefore increase recurring costs associated with extended usage. In addition, they may be susceptible to cross-contamination of the liquid consumables. Evaporation and cross contamination can be expected to be especially important concerns when a fluidic probe is used to aspirate liquids directly from open reagent bottles.

In preferred embodiments of biological detection systems of the invention, reagents are delivered to a fluidic probe through a fluid handling station (in contrast to aspirating the liquids directly from the liquid containers; e.g., reagent bottles, etc.). In certain preferred embodiments, the fluid handling station would include a fluid aspiration chamber from which a probe may aspirate the requisite fluids. In such an embodiment, a pump would preferably be used to push (i.e., through positive pressure) or, more preferably, draw (i.e., suck) the fluids into the probe. Therefore, the aspiration chamber would preferably be configured with sealing means that create a closed system when the probe accesses the chamber. The aspiration chamber is also, preferably, configured to minimize fluid evaporation, reagent cross contamination, and/or contact of fluids with the sealing means (so as to prevent degradation of the seal).

Turning to FIGS. 4a and 4b, a fluid handling station 400 can be employed and configured, in accordance with one preferred embodiment, to supply to a probe 405 the appropriate liquids through an access, or dispense, port 455 for aspiration into the flow cell. A fluidic probe 405 (e.g., a pipettor, pipet tip, syringe needle, cannula, etc.) may be used to access an aspiration chamber 450 of the fluid handling station 400 at port 455 to aspirate the appropriate liquids. Aspiration chamber 450 is connected to reagents through reagent lines 430 and 435 and reagent valves 431 and 436 and to air through air line 440 and valve 441. Probe 405 can be sealed against fluid handling station 400 to form a closed system, preferably by utilizing a face sealing configuration located above the reagent inputs.

FIG. 4a-c depict one preferred embodiment of a fluid handling station employing a face seal. Probe 405 is inserted into aspiration chamber 450 of the fluid handling station body 425. Preferably, the probe 405 is configured with a sealing surface 410, e.g., flange, shoulder, collar, or the like, that is brought into sealing relation with a sealing surface 415 of the fluid handling station body 425. Preferably, one of the sealing surfaces 410 or 415, most preferably sealing surface 415, comprises a gasket or o-ring for forming a fluid and air tight seal. In one embodiment, the o-ring or gasket is partially inset into a sealing surface of the block 425 leaving at least some portion of the o-ring, adequate for a compression seal, exposed above the surface of the block. Insetting the o-ring or gasket into an appropriate groove will provide physical retention and prevent dislodgement during operation.

In operation, the probe is lowered to form the face seal in order to aspirate reagents, more preferably, the lowering comprises compressing sealing surface 410 against sealing surface 415 so as to form a compression seal. Preferably the reagent level 422 of liquid reagent 420 is maintained so that when the probe 405 is lowered into position in the aspiration chamber 450, the volume of the probe displaces the reagent level 422 so that it is slightly above the reagent input lines 430, 435 for the liquid reagents. This configuration allows the probe 405, when properly positioned within the aspiration chamber 450, to form a closed system for drawing (i.e., sucking, pumping, etc.) the reagents from the reagent input-lines 430, 435 which are controlled by valves 431 and 436.

During aspiration of reagents, the tip of probe 405 is, advantageously, lower than reagent lines 430 and 435 so that the flow of reagents efficiently cleans the probe surface and washes away any previous reagents that were held in aspiration chamber 450. This cleaning and washing effect is especially efficient if aspiration chamber 450 is only slightly larger in width or diameter (preferably less than 100% large, more preferably less than 50% larger, most preferably less than 20% larger) than probe 405. In addition, it is preferable to arrange and configure the entry points of the reagent input lines 430, 435 so that their fluid paths enter the aspiration chamber 450 at substantially the same height as one another. This provides an additional advantage for proper flushing between reagents.

Air line 440 is preferably arranged sufficiently above the liquid reagent lines 430, 435 in order to maintain a vertical separation between the air line 440 and the liquid reagent lines 430, 435. Advantageously, this reduces or eliminates the contamination of the air lines 440 with liquid reagents. It also allows the aspiration of a bolus of air into the probe to be used to clear excess reagent from aspiration chamber 450 and/or to prevent mixing of reagents in the probe or subsequent fluid lines (i.e., by separating the reagents in the fluid lines into so-called “slugs” of fluid separated by boluses of air).

In accordance with one or more of these preferred embodiments, certain advantages may be realized. For example, evaporation can be substantially reduced or eliminated and the reproducibility of reagent aspiration can be improved by employing methods and apparatuses that wet a consistent and controlled length of the probe. Furthermore, certain preferred embodiments can be configured such that only a very small reagent surface is exposed to the ambient environment resulting in an even further reduction in susceptibility to evaporation. Still even further, incorporating a seal that is not wetted can substantially eliminate or reduce possible cross-contamination and/or seal degradation due to solids buildup. Finally, the probe can be drawn vertically out of a fluid filled chamber allowing the fluid in the chamber to wick fluid off the outside of the probe (e.g., due to the effects of surface tension in the narrow chamber).

As can be seen in FIG. 4b, raising the probe 405 out of aspiration chamber 450 does not lead to wetting of the seal 415. Instead, the o-ring seal 415 remains dry as the probe 405 is raised due to the lowering of reagent level 422. To reduce the reagent level 422 further, the system can aspirate through the probe 405 as the probe is being raised. Optionally, fluid can also be drawn into the probe 405 as the probe is lowered to further reduce mixing of reagents during transitions.

Reagent Detection Subsystem

Preferably, biological detection systems involving the movement of liquids and/or gases incorporate means and/or methods for determining the presence or absence of the liquids at various locations throughout the system; e.g., the presence or absence of reagents in reagent bottles or fluid lines. Additionally, discriminating between certain liquids/gases may also be advantageous. Finally, preferred biological detection systems may also employ means for determining the volume of liquids as they are routed through the system. According to a preferred embodiment, means and/or methods are provided for determining if a fluid is present in a fluid line and/or for distinguishing between two or more alternative fluids that may be present in a fluid line. The means and/or methods are based on detecting differences in the refractive index of the fluid(s) relative to each other or to air. The fluids may possess very different indices of refraction (e.g., air and water; refractive index difference of 0.3) or may possess very similar indices of refraction (e.g., 1.0 Molar NaCl and 0.4 Molar NaCl aqueous solutions; refractive index difference of 0.006).

In one preferred embodiment, a biological detection system is configured to use liquid-handling instrumentation for aqueous-based liquids and air where the air and liquids travel in the same fluidic system. As previously indicated, it may be desirable to know whether air or liquid is in a given spot at a certain time; e.g., the presence of air in the reagent inlets may indicate the reagent bottles need to be refilled/replaced. Additionally, in preferred embodiments, monitoring when an air bubble crosses a defined point in a fluidic system (e.g., by introducing an air bubble into a fluidic line and measuring the time required for the bubble to travel to the defined point) can be used to diagnose many fluidic issues; e.g., the rate of flow within the fluidic system, the volume inside the tubes; the hydrodynamic resistance of the tubing; the presence of a clogged tube; etc.

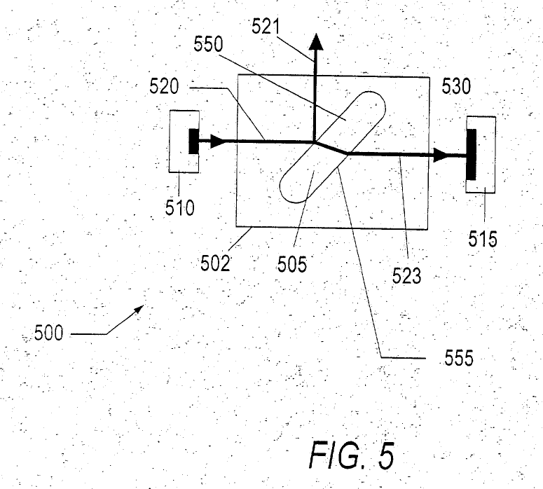

The operational principles of a preferred optically based, non-contact method and device are depicted in FIG. 5. According to one preferred embodiment, device 500 comprises an optical emitter 510 and detector 515 pair that are configured to measure the transmission of light through a fluid conduit 505 (shown in cross-section). The optical emitter is a conventional light source such as an LED, laser, incandescent bulb, fluorescent bulb, electroluminescent display, etc. The optical detector is a conventional light detector such as a photodiode, phototransistor, etc. In particularly preferred embodiments, the emitter and detector pair 510, 515 is a one-piece sensor-transmitter; e.g., those that are commercially available from Omron Corp. Detector 515 is configured to detect light emitted by emitter 510 (shown as light path 520) and transmitted through a fluid conduit 505 (shown as light path 523). Fluid conduit 505 is preferably defined within a transparent or translucent body 502 and arranged such that the fluid pathway intersects the optical axis defined between the emitter and detector pair 510, 515 (i.e., the light path for light transmitted from emitter 510 to detector 515). The emitter and detector 510, 515 are preferably aligned in facing relation to one another on the optical axis.

Fluid conduit 505 comprises first and second fluid interface surfaces 550 and 555 that intersect the light path of transmitted light. Body 502 comprises first and second exterior surfaces 557 and 559 that intersect the light path of transmitted light. Optionally, emitter 510 and/or detector 515 may be incorporated within or placed directly against body 502 so as to eliminate any gap between them and exterior surfaces 557 and 559. Preferably, first and second fluid interface surfaces are planar and, most preferably, parallel to one another. Preferably, first and second exterior surface are planar and, most preferably, parallel to one another. In a particularly preferred embodiment, fluid conduit 505 is configured to have an ob-round cross section (i.e., essentially a rectangular section with rounded corners).

Use of a fluid conduit that comprises planar surfaces for intersecting the light path substantially decreases the need for precise positioning of emitter 510 and detector 515. In alternative embodiments, further improvement may be obtained by arranging fluid interfaces surfaces 550 and 555 at an angle relative to the light path other than perpendicular. For instance, when light has-an angle of incidence with respect to a fluid conduit wall of zero degrees from normal (i.e., perpendicular to the wall), the fraction of light transmitted through the boundary would be proportional to the square-of the ratio of the index of refractions of the fluid conduit wall and the fluid. Accordingly, the ratio of transmitted light for two different fluids in the flat-sided, zero degree angle of incidence fluid conduit would be the square root of the ratio of the refractive indices of the two fluids. The signal modulation resulting from the replacement of water (refractive index ˜1.3) with air (refractive index ˜1.0) would only be ˜1.3/1)^{1/2}=14%. The small magnitude of signal modulation using this arrangement makes reproducible discrimination of the fluids difficult and makes the system susceptible to problems associated with drifts in detector or emitter performance or to problems associated with interfering substances (e.g., colored materials) in the fluid stream.

An increase in detector modulation can be obtained, in accordance with a preferred embodiment, by arranging the relational disposition between the optical axis of the emitter/detector pair 510, 515 and the fluid pathway 505 such that the surface 550 (and, preferably, surface 555) of fluid conduit 550 intersects the light path of transmitted light at a predetermined/predefined angle of incidence 540 other than perpendicular. The angle of incidence would preferably be selected to maximize the discrimination between two fluids of interest (preferably, water and air), e.g., by maximizing the differences in light transmittance observed when these fluids are in conduit 550. Such an increase in detector modulation advantageously permits discrimination between two fluids having only a small refractive index difference (preferably, as small as 0.1, more preferably as small as 0.03, most preferably as small as 0.01), reduces possible interferences to the measurement and permits the use of simplified detector/emitter designs.

Advantageously, the material in body 502 that forms surfaces 550 and 555 has an index or refraction that is greater than at least one, or preferably, both of the two fluids to be discriminated. In one embodiment, the refractive index of this material is greater than or equal to 1.4 or, more preferably; 1.5. Suitable materials include glass and clear plastics (e.g., Lexan, acrylic, polycarbonate, Perspex, Lucite, Acrylite, polystyrene, etc.), most preferably acrylic. For embodiments adapted to discriminate between air and liquid reagents (preferably, aqueous reagents), the angle of incidence of light on surface 550 is, preferably greater than the critical angle when air is present in conduit 505 and less than the critical angle when the liquid reagent is present in conduit 505. The material of body 502 and the angle of incidence of light on surface 550 are, preferably, selected so that less than 20% (more preferably less than 5%, most preferably less than 1%) of light striking surface 550 is reflected when the fluid reagent is present in conduit 505. Especially preferred angles of incidence are within the range of 40-63 degrees or more preferably 42-63 degrees, or more preferably 45-60 degrees; these ranges have been found to be particularly useful when discriminating between air and aqueous reagents in a fluid conduit made out of acrylic (refractive index ˜1.5) but should also be useful for other plastics since many have similar indices of refraction.

In a still further preferred embodiment, the fluid conduit 505 is also positioned such that the transmitted beam 523, i.e., the beam of light that is transmitted through conduit 505, is minimally offset due to refraction. Alternatively, the optical detector 515 can be-positioned such that any offset is taken into account, e.g., by offsetting the detector relative to the path that the light would take if there was no change in refractive index along the path. Similarly, the detector may need to be offset to account for refraction of light at exterior surfaces 557 and 559; the need for this offset can be eliminated by making exterior surfaces 557 and 559 perpendicular to the path of light (thus also minimizing the loss of light due to reflection of light off these surfaces). It should be noted that it is not necessary for the entire fluid handling body to be transparent/translucent. For example, it may be sufficient for only the portion, or portions, of the fluid handling body that are in optical registration with the detection device to be transparent/translucent.

In a preferred embodiment of device 500, the transparent/translucent body 502 is fabricated from acrylic. Light traveling through an acrylic block and hitting a fluid conduit, that either contains air or liquid can both reflect and transmit at the boundary depending upon the angle of incidence of the light upon the surface(s) of the channel. The percentage of light that is reflected and/or transmitted is a function of the refractive indices of the block material and the fluid in the conduit and can be explicitly calculated using the Fresnel equation. The calculated values can be used to select angles of incidence that maximize the discrimination between two fluids. The analysis used to select an appropriate angle of incidence for a preferred system that discriminates between air and an aqueous reagent is described below.

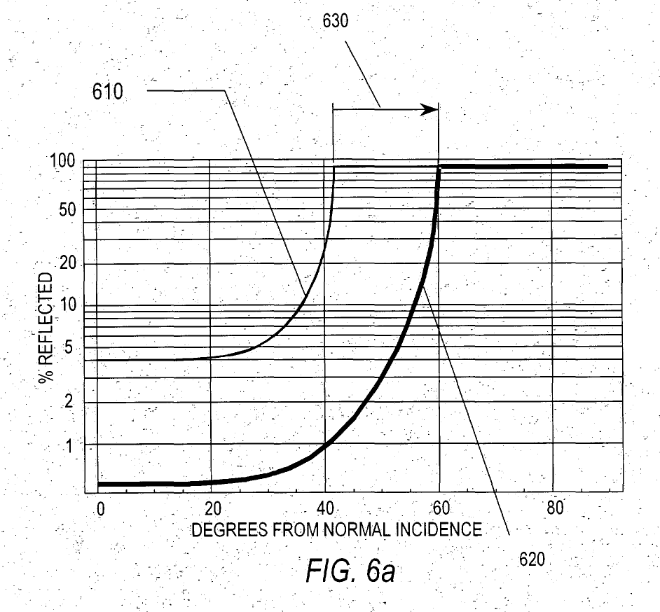

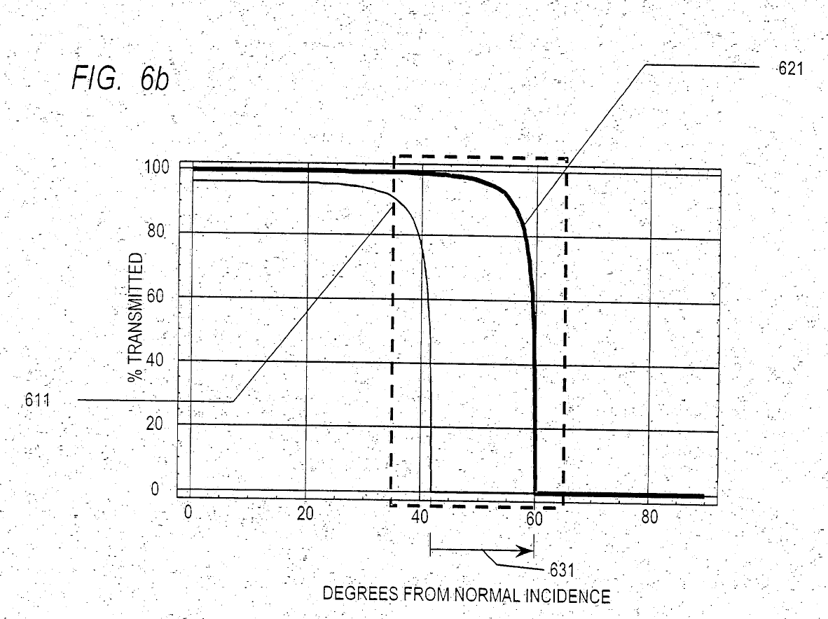

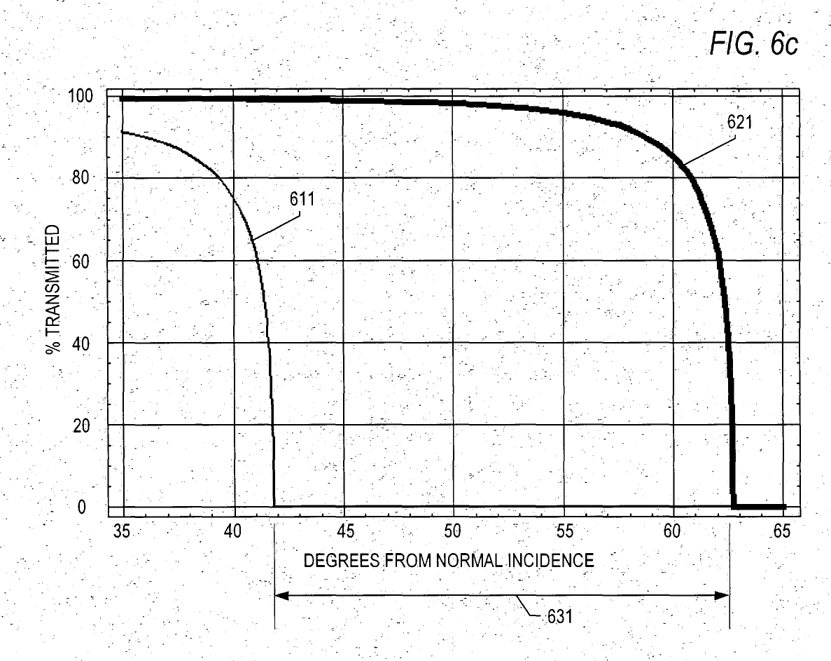

FIGS. 6a and 6b illustrate reflectance and transmittance performance curves (power reflected and transmitted) as a function of the angle of incidence of light for light hitting surface 550 of fluid conduit 505 for an acrylic-block having a fluid conduit that carries both air and aqueous based fluids; i.e., FIGS. 6a and 6b provide the computed amount of light that would be transmitted and reflected from an acrylic—water interface (curves 620 and 621) and an acrylic—air interface (curves 610 and 611). The indices of refraction used for generating these curves are: acrylic=1.5; aqueous based fluid=1.3; and air=1.

In accordance with FIG. 6b, one particularly preferred embodiment resulting in high discrimination can be achieved by employing a system configured to detect the transmitted light. In particular FIG. 6b illustrates that positioning the fluid pathway so that it intersects the optical axis at substantially a 45° angle results in a predicted infinite modulation ratio. If air is present in the fluid conduit, 0% of the light would be transmitted through surface 550. Conversely, if liquid is in the fluid conduit, 97% of the light would be transmitted. Substantial discrimination of air from water should also be possible for angles of incidence ranging from 40-60 degrees, more preferably from 42-60 degrees or most preferably from 45-60 degrees. The excellent discrimination predicted by these curves indicates that the system will have a high tolerance for instrument drift and chemical interferences (such as the presence of light absorbing compounds) that could make the amount of transmitted light appear artificially low.

Alternatively, in accordance with FIG. 6a, another preferred embodiment could employ a system configured to detect reflected light (i.e., having a light detector positioned to detect reflected light as opposed to transmitted light). Reflected light methods might be preferred if it was necessary to discriminate between each of the multiple liquids as well as air and if at least some of the liquids strongly absorbed the transmitted light. Reflection-based methods, however, provide less signal modulation and require a more complicated instrumental set-up and alignment. In reflection-based systems, positioning the fluid pathway so that it intersects the optical axis at substantially a 45° angle, a modulation ratio of 67 would be achieved since 100% of the light would be reflected at the first surface if air is in the line and 1.5% reflected at the first surface if water is in the line. It should be noted also that the 1.5% reflected may be increased slightly by reflections on the second surface; i.e., the water—acrylic surface on the other side of the liquid passageway.

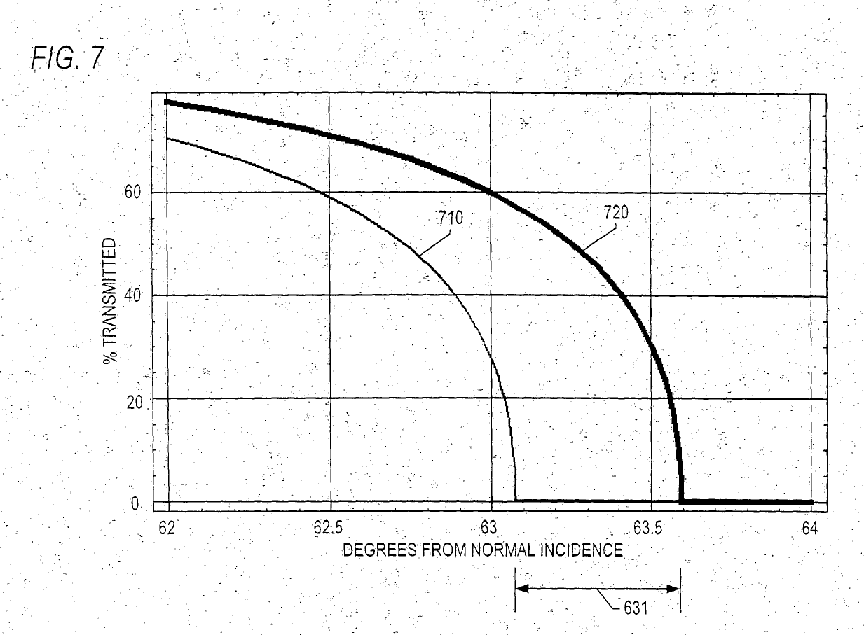

High discrimination, non-contact, optical detectors and emitters, in accordance with preferred embodiments, can be employed in conjunction with appropriately arranged and configured fluidic pathways to also allow differentiation of liquids having indices of refraction that differ by only a very small amount. For example, using the configuration depicted in FIG. 5, FIG. 7 illustrates the computed transmittance curves of two representative fluids whose refractive indices vary by an amount equal to only 0.0061. As can be seen, light incident to the fluid/wall interface at an angle of 63.2° would-be totally reflected by one fluid 710, while the other fluid 720 would transmit over 50% of the incident light. It should be noted that the ability to conduct such a sensitive discrimination is limited by the tolerance for the angle of incidence (which may in turn be limited by manufacturing tolerances and the divergence of the light beam along the light path). The angle of incidence should be prescribed to within ˜0.5 degrees to optimally distinguish between two fluids having refractive indices that vary by 0.0061. In preferred embodiments of the invention, the angle of incidence is prescribed to within 5 degrees, more preferably to within 2 degrees and most preferably to within 0.55 degrees.

Modulation ratios can be computed for selected body materials and liquids according to theoretical predictions. However, it should be understood by those skilled in the art that in practice, actual modulation ratios can vary from the theoretically computed values because of issues pertaining to, e.g., surface roughness (creating a range of actual incident angles), background light (increasing the value of the light measured at the detector), noise in the detector, and the like.

In certain preferred embodiments it may be desirable to include multiple fluid detection devices (e.g., the preferred devices described above), one for each of the reagent lines used to introduce reagents into a biological detection systems. In such an embodiment, the detection devices would preferably be housed within the same transparent/translucent body.

Positive Displacement Pump Improvements

Deployment of biological detection systems in the field, whether subjected to frequent usage (e.g., 24 hours a day, seven days a week for high throughput screening) or more infrequent usage (e.g., periodic use for point of care settings), will inevitably result in the need for periodic maintenance. In order to minimize the requirement for maintenance, improve reliability and reduce the complexity of fluidic systems, it is advantageous to minimize the number of valves in the system. In certain instances, maintenance of the system will require servicing by skilled technicians and therefore may require that the system, or a subsystem/component/subcomponent, be shipped to the manufacturer or a qualified maintenance and repair facility. If the system has contacted potentially pathogenic biological samples, it may be necessary to decontaminate the system prior to shipping. In systems that employ pumps, especially positive displacement pumps, it is preferable to have provisions in the biological detection system for-decontaminating the fluidic system in the event of failure of the fluidic control system, e.g., pump failure or seizure, without requiring disassembly of the pump or fluidic system.

In addition to being maintainable, a biological detection system, in particular flow cell based systems, would preferably be designed to operate reliably and consistently despite handling potentially difficult samples and reagents that may include air bubbles and particulate matter (e.g., particulate matter in complex samples such as blood or environmental samples and/or particulate solid phase supports such as magnetizable particles). Accordingly, pumps used in biological systems will, advantageously, be able to pass air bubbles and particulate matter without a reduction in reliability, or precision and are, preferably, adapted to purge air and particulate matter from pump chambers. Particular attention must be paid to air bubbles in fluidic systems because air may get trapped in the pump or fluid lines, change the compliance of the fluidic system, and reduce the precision with which fluid flow can be controlled. Furthermore, particulate matter may settle in fluid lines or pump chambers and become trapped, causing clogs in the fluidic system.

Pump Chamber Cleanout Plug

It is generally necessary to decontaminate contaminated biological testing devices before they can be shipped for, e.g., scheduled maintenance, repair, etc. Most commercially available positive displacement pumps utilize a single port (typically connected to a 3-way valve) to flow fluid into and out of the pump. This configuration, however, creates a dead-end system resulting in a situation where the only way to decontaminate the pump chamber is through actuation/motion of the piston to cause fluid to flow through the system. Disadvantageously, failure of the piston in such a configuration would result in decontamination being made very difficult, if not impossible.

In one preferred embodiment, a fluidic system operates under the influence of a positive displacement piston pump. In such a configuration, failure of a-conventional piston pump could result in hazardous materials/substances being trapped within the pump's piston chamber (i.e., while the pump is inoperative, fluids that remain in the system, particularly those found within the pumps piston chamber, could not be exchanged under the influence of the pump).

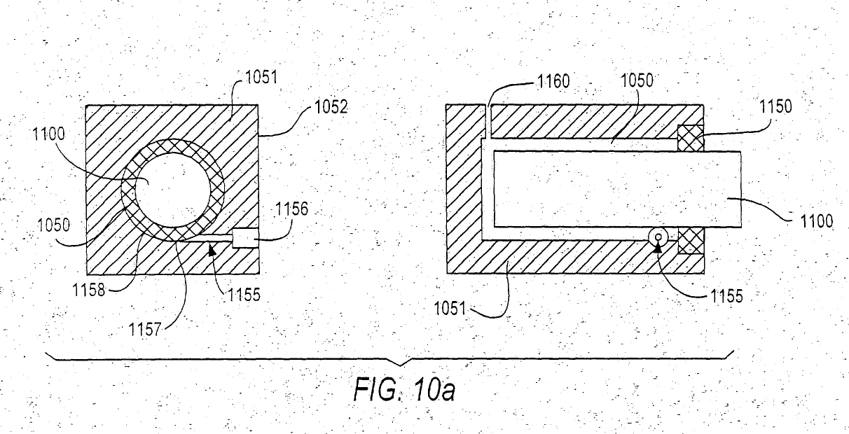

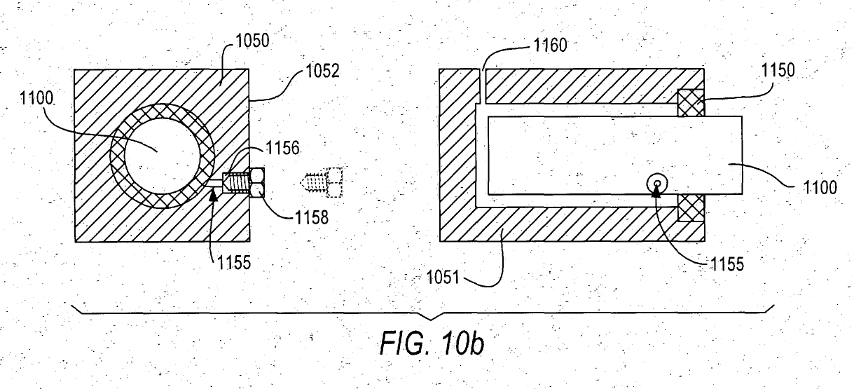

In accordance with one preferred embodiment, FIG. 10a depicts a modified positive displacement piston pump that is adapted and configured with a cleanout plug system for decontaminating the piston chamber of the pump in the event that the pump piston ceases to function. Pump chamber 1051 comprises opening 1050, an opening adapted to receive pump piston 1100 and input fluidic path 1160, a second opening from which the pump aspirates and dispenses fluids. Pump chamber 1051 also has a cleanout fluid path 1155, an additional opening located, preferably, at the opposite end of the chamber from the input fluidic path 1160. Access to the cleanout fluid path 1155 is preferably provided through a resealable access port 1156, e.g., by adding a removable plug (shown in the alternative embodiment of FIG. 10b). Advantageously, this preferred cleanout plug system would permit decontamination of the piston chamber in the event of a piston failure.

Chamber body 1051 houses the piston 1100 and the piston seal 1150. Preferably, the chamber entry point 1157 of cleanout fluid path 1155 is arranged to be substantially tangent to the interior wall 1158 of the piston chamber 1051 thus creating a directed, generally circular or helical path for fluid flow around the piston 1100 and allowing for efficient cleaning and decontamination of the pump chamber.

In operation, arranging and configuring the cleanout fluid path 1155 in such a manner allows a decontaminating solution to be introduced into the cleanout fluid path 1155 and preferably circulate around the piston 1100 creating a flow path with minimal dead zones around the piston 11100. Accordingly, the flow would preferably continue in a spiral path around and along the piston and exit through the input fluid path 1160 thus substantially decontaminating the piston chamber 1050.

FIG. 10b depicts one possible alternative embodiment that is less complex to manufacture and requires, less stringent manufacturing tolerances. In particular, locating the cleanout fluid path 1155 slightly toward the center of the piston chamber 1050 reduces the manufacturing difficulties while retaining the desired fluid flow characteristics. Appropriately arranging the cleanout fluid path 1155 in relation to the piston 1100 and pump chamber 1050 allows' the flow to proceed in one direction around the piston 1100.

One preferred embodiment for providing an accessible seal to the cleanout fluid path employs a removable sealing device, e.g., plug 1158, that is inserted into cleanout access port 1156. More preferably, a threaded sealing plug is sealingly inserted into the access port 1156 of the cleanout fluid path 1155. Most preferably, access port 1156 is also threaded so as to provide a tight seal to the threaded plug.

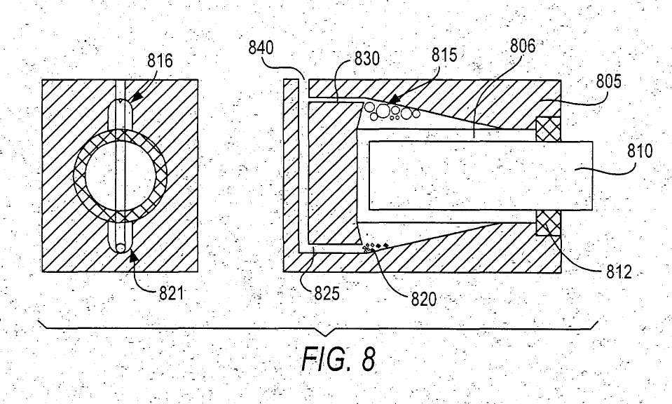

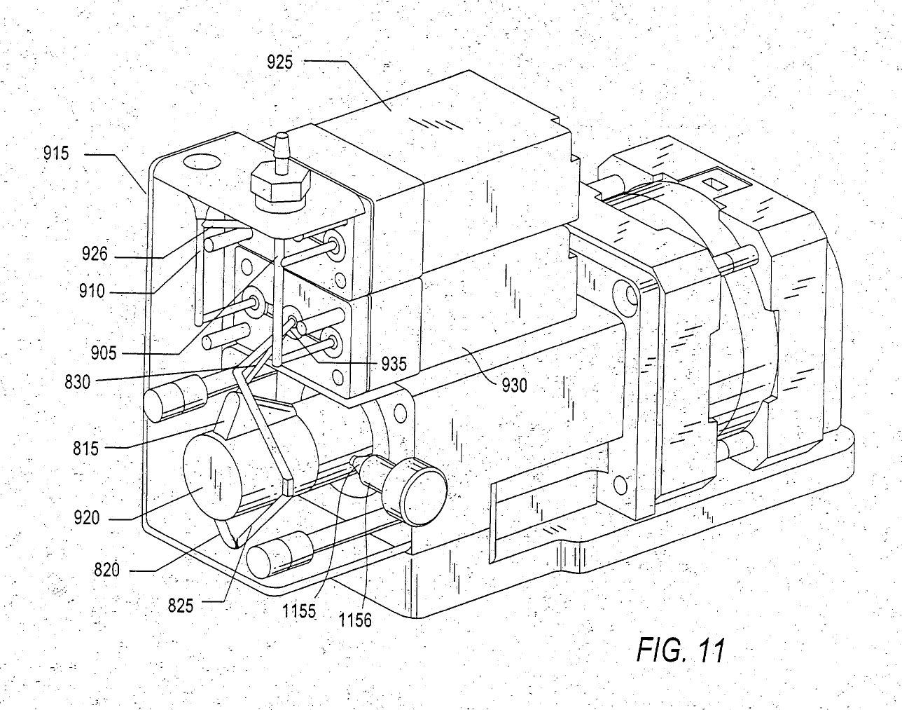

FIG. 11 depicts one possible preferred embodiment of an overall pump assembly incorporating the features of the modified pump head assembly and modified pump chamber of FIGS. 8-10b.

Self-Cleaning Pump Head

Yet another consideration for the design and use of flow-cell based systems is that positive displacement pumps used in fluidic control systems may periodically trap/accumulate foreign materials in the pump chamber, such as, e.g., gas bubbles and/or solid sediment (e.g., magnetic beads). Gas bubbles contribute to compliance and adversely effect pumping precision. Compliance results from the fact that gases are compressible, or compliant, while liquids are generally incompressible. In the presence of gas, displacement of the piston may lead to compression of gas instead of the expected displacement of fluid. Solid sediments can damage piston seals and/or eventually accumulate and block proper operation of the pump. It is therefore preferable to purge such foreign materials from the pump chamber.

In accordance with one embodiment, method(s) and devices can be employed to accomplish the purging of these foreign materials without the need for additional valves or controls thereby allowing for optimal operation of the pump and for potentially extending the life of the pump. Specifically, a positive displacement pump can be adapted and configured to utilize passages for purging both gases and sediments without the need for additional valves or other externally controlled flow devices. These passages, or channels, are preferably proportioned and positioned with respect to one another to automatically, and passively, remove both the gases and the solid sediments from the pump chamber.

FIG. 8 depicts a pump chamber body/housing 805 adapted and configured in accordance with one preferred embodiment. The pump chamber body/housing 805 defines the pump chamber opening 806, adapted to receive piston 810. Pump chamber body/housing 805 further comprises fluidic seal 812 (an o-ring, gasket, compression gasket, reciprocating seal, spring energized reciprocating seal or the like) for sealing piston 810 against opening 806. The sealing surface of fluidic seal 812 is, preferably, made of a chemically resistant material such as PTFB. Pump chamber body 805 is adapted to include two angled grooves 821 and 816 forming sediment and gas traps 820, 815, respectively; the two angled grooves having certain predefined inclination angles selected to achieve optimal accumulation of gas bubbles and sediment while maintaining machinability. Angled groove 821 is arranged at the bottom of the pump chamber opening 806 and is configured to accumulate sediment towards the bottom of the ramp; the accumulation of sediment is enhanced through the action of gravity which tends to move the sediment toward the bottom of the ramp. Angled groove 816 is arranged at the top of the chamber opening 806 and is configured to accumulate gas bubbles at the topmost point; the accumulation of gas bubbles is enhanced by the buoyancy of the bubbles. In operation, this preferred configuration of the pump chamber allows materials to pass through the pump chamber while preferably accumulating solids at the bottom of the chamber in the sediment trap 820 and gas bubbles at the top of the chamber in the gas trap 815.

Pump chamber body 805 is further configured to include two fluid passages 825 and 830 exiting the chamber from the uppermost and bottommost points of the gas and sediment traps 815, 820, respectively. The exit passages 825, 830 are preferably sized to take advantage of the differential in viscosity between the various liquids/gases employed in the system; e.g., aqueous based solution and air. Appropriate sizing of the passages in accordance with preferred embodiments results in a passive, or virtual, valve for causing the fluid flowing through the system to be directed, at least in part, out of either the gas exit passage or the sediment exit passage, or both.

As would be appreciated by a person of ordinary skill in the art, fluid flowing through a system will normally seek out the path(s) of least resistance as it would require the least amount of energy to traverse. Exit passages 825, 830 are preferably sized and arranged such that the fluidic resistance of gas through exit passage 830 is less than the fluidic resistance for liquid through exit passage 825, so that when air is present within gas trap 815, a compressive piston stroke will first purge the air from the gas trap 815 through gas exit passage 830 prior to displacing substantial amounts of liquid. Accordingly, when the pump is used for the aspiration or dispensing of precise volumes of liquid, it is preferable to apply a first piston movement to purge air from the air trap and then a second piston movement to accomplish the precise aspiration or dispensing of liquid.

In accordance with a preferred aspect of the invention, once the gas/air bubbles that had accumulated in the gas trap 815 are forced/driven out of the pump chamber, the resistance in the gas exit passage 830 increases and, preferably becomes greater than the resistance offered by the sediment exit passage 825 (i.e., exit passages 825 and 830 are sized so that the fluidic resistance of liquid through passage 825 is, preferably, equal to, or, more preferably, greater than the fluidic resistance of liquid through passage 830). Continued compressive displacement of the pump piston thereby causes at least a portion of the fluid, and preferably substantially all of the fluid, to be directed out of the sediment exit passage 825. Specifically, once the gas has been purged, the ratio of the flow of liquid through the two passages 825, 830 becomes inversely proportional to the ratio of the fluidic resistances for this liquid (where fluidic resistance is roughly proportional, for a tube having a constant diameter, to the ratio of tube length divided by the fourth power of the diameter). The increased flow through exit passage 825 results in the purging of particulates from sediment trap 825.

Therefore, when either gas or sediment, or both, accumulate within the pump chamber, the preferred passive/virtual valve system described above would cause the fluid flowing through the pump to be directed out of the pump, first via the gas exit passage 830 until substantially all of the trapped gas has been removed or forced out, and then via the sediment exit passage 825 causing substantially all of the sediment to be removed or forced out.

In a preferred embodiment of the invention, gas exit passage 830 will comprise a cross-sectional area that is equal to or smaller (more preferably, smaller, most preferably, at least two times smaller) than the sediment exit passage 825 so that, in the absence of air, liquid is equally or preferentially directed through exit passage 825 relative to exit passage 830. Because of the lower viscosity of air than liquid, gas exit passage 830 can be substantially smaller in cross-sectional area than sediment exit passage 825 while still meeting the condition that the fluidic resistance of gas through exit passage 830 is less than the fluidic resistance for liquid through exit passage 825. Such a system preferably first purges the gas bubbles (using a small amount of liquid) and then purges the sediments by having a greater rate of flow out of the sediment exit passage 825. Advantageously, such a passive/virtual valving system and method accomplish the task of purging the system of undesirable gas and sedimentations using only the, principles of fluid dynamics; the need for active components or externally controlled flow control devices is preferably eliminated.

In particularly preferred embodiments, the exit passages are combined after they leave the pump chamber body 805 to form a single fluid interface line 840. This connection of the exit passages may be achieved within pump chamber body 805 (as shown in FIG. 8) or, alternatively, may be accomplished via a fluidic tee connection that is external to pump chamber body 805. In still further preferred embodiments, and particularly those employing relatively low flow rates, the fluid paths are preferably combined as they flow in an upward direction. Advantageously, this arrangement ensures clearance of air bubbles from the fluid interface line.

Pump Bypass Valve

Clogging of fluidic systems is often times an ongoing concern and may require resolution by the system operator. Moreover, in systems using a positive displacement pump, clogging can be particularly problematic since positive displacement pumps are quite often constructed in a manner that creates a dead-end fluid channel. Dead end fluid channels do not permit use of a manually actuated flow for the purpose of unclogging the fluid path; e.g. by manually back washing/flushing the fluidic system.

Back flushing (e.g., manually, or through automated means) is preferred over using the fluidic systems pump to clear clogs since the pump could create excessive and sometimes unsafe pressures that could damage sensitive fluidic components. In addition, certain preferred embodiments may employ the placement of a deliberate flow constriction within the fluidic system near the fluidic systems origin, or input (e.g., in the tip of a fluidic probe). Such a configuration may be useful for catching/trapping materials that may lead to clogging of the system before they enter more sensitive regions of the fluidic system. Continued use of the pump would likely only draw the clogging material further into the system and possibly lead to excessive pressures, excessive wear of system components and/or catastrophic failure of the pump and/or the fluidic control system.

Back flushing, or pulling, the clog is preferred to pushing the clog since pushing, or forcing, a clog through the system in the normal direction of flow will often times lead to exacerbation of the problem. Compliant clogs can compress under pressure, increasing their diameters, and increasing the difficulty of dislodging the clog. Conversely, by pulling a vacuum, i.e., back flushing, compliant clogs preferably stretch and reduce their diameters, making their removal easier. By way of simple analogy, typical clogs in fluidic systems that process biological materials can be likened to a strand of spaghetti. It would be easier to pull a strand of spaghetti through a tube having a diameter substantially equivalent to the diameter of the strand of spaghetti than it would be to push the strand of spaghetti through the same tube.

One common dead-end configuration for a positive displacement pump utilizes a three-way valve having a first port linked to a first fluid line (e.g., a fluid inlet), a second port linked to a second fluid line (e.g., a fluid outlet line) and a common port linked to a pump chamber interface line from which the pump aspirates and dispenses fluid. In accordance with one embodiment, this dead-end configuration can be overcome by bridging the first and second fluid lines with a valve that could act to bypass the pump chamber and thus permit the system to be manually back flushed of the pump chamber. In this case activating the bypass valve allows manual movement of fluids through the fluidic system. In a most preferred embodiment, the number of fluidic connections in the system can be reduced by mounting both the normal control valve for the pump (e.g., the three way control valve described above) and the bypass valve (e.g., a shut-off valve) onto the pump head.

According to an alternate embodiment, the functions of the control valve and the bypass valve can be combined into a single 3-port 3-position valve that is configured to allow connection of any two ports. The 3-port 3-position valve is connected to the first fluid line, the second fluid line and the pump interface line, allowing for selective coupling of the first fluid line to the pump interface line, the second fluid line to the pump interface line, or the bypass condition wherein the first fluid line is connected to the second fluid line.

In accordance with preferred embodiments, the unclogging of blocked fluidic passages is achieved by creating a flow-through fluid path that can be acted on externally to back wash the clog out of the fluid path; e.g., by using a manually operated syringe. Such embodiments overcome the problems associated with the dead-end fluidic configurations normally found in positive displacement pump systems and employ simple devices and/or device configurations that do not require disassembly of the fluidic system by means of tools.

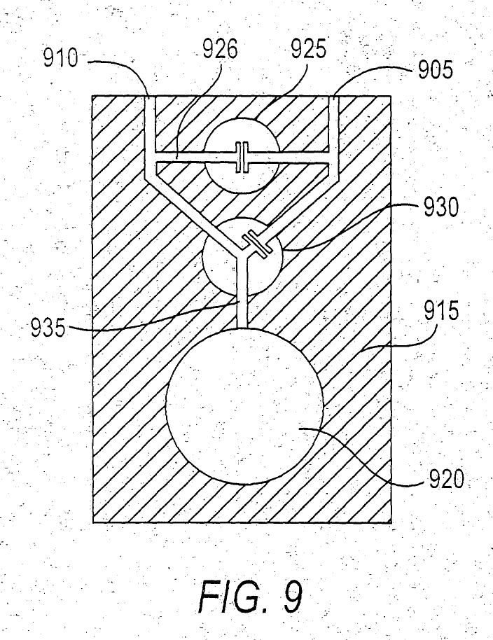

FIG. 9 illustrates one preferred embodiment of the invention wherein, for simplicity, all the fluid passages are shown cut into the chamber body 915 of a typical pump. In normal operation of the pump, the first half of the piston stroke cycle causes fluid to flow through the input fluid line 905, through the input port and common ports of valve 930, through pump interface line 935 and into the pump chamber 920. Note, piston details have been omitted for clarity. During the second half of the piston stroke cycle, valve 930 would then be switched, attaching pump interface line 935 to the output fluid line 910, allowing the fluid to be expelled and thus completing a full pump stroke cycle. This configuration allows line 935 to be connected to either line 905 or line 910, but as such does not allow for back flushing of the system from the input line 905 to the output line 910. In accordance with one preferred embodiment, the system is adapted and configured to accomplish back flushing by creating a fluidic connection between the input line 905 and the output line 910 ports and controlling this fluidic connection through a bypass valve 925. Preferably, the bypass valve 925 is provided within the back flush fluid passage 926 to allow the fluid passage to be selectively activated and controlled. For example, when bypass valve 925 is opened, a direct link is created between the input line 905 and output line 910 thus allowing the system to be back flushed; e.g., manually, automatically, under computer control, etc.

The preferred embodiment of FIG. 9 advantageously reduces part count, simplifies fluidic connections and reduces fluidic path lengths in the system by integrating the valves and fluid lines into the pump housing. However, in an alternative embodiment, a system having valves connected to a pump through tubing and tubing connections could also be employed to accomplish the back flushing function.

The present invention is not to be limited in scope by the specific embodiments described herein. Indeed, various modifications of the invention in addition to those described herein will become apparent to those skilled in the art from the foregoing description and accompanying figures. Such modifications are intended to fall within the scope of the claims.

What is claimed is:

1. An apparatus for retaining a plate wherein the plate may have any one of a plurality of different predetermined flange heights, the apparatus comprising:
a first positioning block comprising a retractably mounted first positioning arm, the first positioning block having a first plurality of retaining ledges; and
a second positioning block having a second plurality of retaining ledges,
where in at least one of the first plurality of retaining ledges is defined on the first positioning arm and the first and second positioning blocks are arranged to engagingly receive the plate and the first arm is adapted to selectively apply a first biasing force upon the plate to position the plate under at least one of the second plurality of retaining ledges.

2. An apparatus for positioning a plate in a, predetermined plate alignment position, the apparatus comprising:
a plate loader adapted to translate along a translation path;
a first positioning block having a retractably mounted first positioning arm;
a second positioning block;
a plurality of plate positioning stops arranged in accordance with the predetermined plate alignment position;
wherein the plate loader is adapted to loosely receive the plate and translate the plate between the first and second positioning blocks, the first and second positioning blocks being arranged to engagingly receive the plate, and
wherein the first positioning arm is adapted to selectively apply a first biasing force upon the plate to position the plate in the predetermined plate alignment position.

3. The apparatus of claim 2 wherein at least one of the plurality of positioning stops is a first positioning stop and is arranged on the plate loader to define the predetermined position of the plate along the direction perpendicular to the translation path.

4. The apparatus of, claim 3 wherein the first biasing force pushes the plate against the first positioning stop.

5. The apparatus of claim 2 wherein at least one of the plurality of positioning stops is a second positioning stop and is arranged on the plate loader to define the predetermined position of the plate along the direction parallel to the translation path.

6. The apparatus of claim 5 wherein the first biasing force includes a frictional component force that pushes the plate against the second positioning stop.

7. The apparatus of claims 3 or 5, the plate loader having at least one horizontal surface for supporting the plate wherein the first positioning stop is a rim that at least partially defines a perimeter of the horizontal surface.

8. The apparatus of claims 3 or 5, the plate loader having at least one horizontal surface for supporting the plate wherein the first positioning stop comprises and arrestment surface arranged on a perimeter of the horizontal surface.

9. The apparatus of claim 2, the second positioning block further comprising a retractably mounted second positioning arm wherein the second positioning arm is adapted to apply a second biasing force to the plate that is lesser in magnitude than the first biasing force.

10. The apparatus of claim 1, the second positioning block further comprising a retractably mounted second positioning arm wherein at least one of the second plurality of retaining ledges is defined on the second positioning arm.

11. The apparatus of claim 10, the first positioning block further comprising a retractably mounted third positioning arm wherein at least one other of the first plurality of retaining ledges is defined on the third positioning arm.

12. The apparatus of claim 11 wherein at least one each of the first and second plurality of retaining ledges are first and second positioning block retainer ledges.

13. An apparatus for positioning and retaining a plate in a predetermined plate alignment position, wherein the plate may have any one o'f a plurality of different predetermined flange heights, the apparatus comprising:
a first positioning block comprising a retractably mounted first positioning arm, the first positioning block having a first plurality of retaining ledges, at least one of the first plurality of retaining ledges being defined on the first positioning arm;
a second positioning block having a second plurality of retaining ledges;
a plate loader adapted to translate along a translation path and to loosely receive the plate, wherein the plate loader translates the plate between the first and second positioning blocks that are arranged to engagingly receive the plate; and
a plurality of plate positioning stops arranged in accordance with the predetermined plate alignment position,
wherein the first positioning arm is adapted to selectively apply a first biasing force upon the plate to position the plate in the predetermined plate alignment position under at least one of the second plurality of retaining ledges.

14. A device for detecting proper alignment of a plate, the device comprising:
a sensor housing having arranged therein:
a sensor;
a first retractable lever arm having first and second lever ends; and
at least one spring members arranged between a housing surface and the first lever arm so as to apply a biasing force on said lever arm,
wherein a properly positioned plate will contact each of the first and second lever ends and wherein the sensor is positioned in relation to the first lever arm so that each lever end must be displaced at least a predetermined distance by the plate in order to actuate the sensor.

15. The device of claim 14, wherein said at least one spring member comprises a first and second spring members arranged between the housing surface and the first lever arm so as to apply biasing forces at the first and second lever ends, respectively.

16. The device according to claim 14 wherein the first and second lever ends further comprise first and second lever projections.

17. The device according to claim 14 further comprising:
one or more first lever end stops arranged to restrict the displacement of the first lever end between a first lever end minimum and a first lever end maximum; and
one or more second lever end stop arranged to restrict the displacement of the second lever end between a second lever end minimum and a second lever end maximum.

18. The device according to claim 14, the sensor housing further comprising:
a second retractable lever arm having third and fourth lever ends;
third and fourth spring members arranged between the housing surface and the second lever arm so as to apply biasing forces at the third and fourth lever ends, respectively,
wherein the second retractable lever arm is positioned in relation to the first lever end of the first arm so that each of the third and fourth lever ends must be displaced at least a predetermined distance by the plate in order to displace the first lever end by at least the first predetermined distance.

19. An apparatus for training a probe to locate and aspirate reagents and/or one or more samples, the apparatus comprising:
a movable probe;
a motion control system for moving the probe;
a fixed object having an alignment feature, the alignment feature comprising:
a first opening having a first opening area, the first opening being sized to receive the probe;
a second opening having a second opening area; and
a guiding surface having a guiding angle defined by the relative arrangement of said first and second openings to one another,
wherein said first opening area is greater than said second opening area and said first and second openings are concentrically arranged.

20. An apparatus for training a probe to locate and aspirate reagents and/or one or more samples, the apparatus comprising:
a movable probe;
a motion control system for controlling movement of the probe in at least a first direction along, and at least a second direction perpendicular to, the probe axis; and
a fixed object having an alignment feature, the alignment feature comprising:
a first opening sized in accordance with a fabrication tolerance of the apparatus; and
at least one guiding surface having at least one guiding angle,
wherein the motion control system is Configured to (i) move the probe in the second direction to within an initial estimate of the alignment feature, (ii) release control of the probe so as to allow it to move freely in the second direction, and (iii) move the probe in the first direction into the alignment feature such that the at least one guiding surface guides the probe into precise alignment.

21. The apparatus according to claims 19 or 20 wherein the guiding surface is conical.

22. The apparatus according to claims 19 or 20 wherein the guiding surface is trapezoidal.

23. The apparatus according to claims 19 or 20 wherein the guiding surface is doubly curved.

24. The apparatus according to claim 20 wherein the alignment feature further comprises a second opening; sized to closely receive the probe and arranged below the first opening, the first and second openings being connected by the guiding surface.

25. A method of training a probe to locate and aspirate, reagents and/or one or more samples within a biological detection device, the method comprising the steps of:
a) moving the probe to an initial estimated position of an alignment feature, wherein the probe is moved in at least a first direction along, and at least a second direction perpendicular to, the probe axis, the alignment feature comprising:
a first opening sized in accordance with a fabrication tolerance of the device and at least one guiding surface, having at least one guiding angle;
b) releasing control of the probe's motion in the second direction;
c) advancing the probe a predetermined distance in the first direction,
wherein the probe contacts the guiding surface and is guided in the second direction into an actual position of the alignment feature.

26. The method of claim 25 further comprising the steps of:
d) withdrawing the probe;
e) reactivating control of the probe's motion in the second direction;
f) homing the probe;
g) determining a calibration distance traveled in the second direction; and
h) determining an actual position of the alignment feature in accordance with the initial estimated position and the calibrated distance.

27. The method of claim 26 wherein the probe's motion is controlled by a computerized motion control system having a processor and a memory.

28. The method of claim 27 wherein a set of probe training instructions adapted to control the probe's motion is stored in the memory.

29. The method of claim 28 wherein the probe training instructions include one or more sets of refinement instructions adapted to cause the probe to perform one or more refinement measurements at one or more refinement positions.

30. The method of claim 29 wherein the refinement instructions use the actual position of the alignment feature and the fabrication tolerance to determine the one or more refinement positions.

31. The method Of claim 30 wherein steps a) through h) are repeated for each refinement position.

32. A fluid handling device for aspirating reagents, the device comprising:
a reagent manifold comprising:
an aspiration chamber having an access port, the aspiration chamber being defined within the reagent manifold;
a plurality of reagent input lines;
a gas input line arranged on the aspiration chamber above the plurality of reagent input lines;
a reagent manifold sealing surface,
wherein the reagent input and the gas input lines are in selective fluid communication with the aspiration chamber; and
a movable probe having a probe tip and a probe sealing surface,
wherein the probe sealing surface is adapted to sealingly engage the reagent manifold sealing surface when the probe is lowered into the aspiration chamber.

33. The device according to claim 32, wherein said plurality of reagent input lines are arranged at substantially the same height on the aspiration chamber.

34. The device according to claim 32 further comprising a seal configured to enclose the access port and to form a face seal when the probe is lowered into the aspiration chamber.

35. The device according to claim 34 wherein the seal is selected from the group consisting of an o-ring, a gasket, and an elastomeric material.

36. The device according to claim 35 wherein the seal is arranged on the probe sealing surface.

37. The device according to claim 35 wherein the seal is arranged on the reagent manifold sealing surface.

38. The device according to claim 36 wherein the probe sealing surface has a groove for mounting the seal.

39. The device according to claim 37 wherein the reagent manifold sealing surface has a groove for mounting the seal.

40. The device according to claim 32 further comprising a plurality of independently controlled valves for selectively placing each reagent line in fluid communication with the aspiration chamber.

41. The device according to claim 32 wherein the aspiration chamber and the probe each have a respective diameter, the aspiration chamber diameter being larger than the probe diameter.

42. The device according to claim 41 wherein the aspiration chamber diameter is 25% larger than the probe diameter.

43. The device according to claim 32 wherein the aspiration chamber and the probe each have a respective height, the aspiration chamber height being substantially the same as the probe height.

44. An apparatus for detecting the presence/absence of a reagent having a reagent index of refraction, the apparatus comprising:
a fluid handling manifold having: (i) an exterior; (ii) a transparent light path defined therein; and (iii) a fluid conduit defined therein, wherein at least a portion of the fluid conduit comprises first and second planar fluid interface surfaces that intersect the light path;
a light source adapted to direct light into the light path; and
a light detector configured to detect light transmitted through the light path,
wherein the first and second fluid interface surfaces are arranged at fluid interface angles relative to the light path.

45. The apparatus of claim 44, the fluid handling manifold exterior having first and second planar exterior surfaces wherein the first and second exterior surfaces intersect the light path.

46. The apparatus of claim 45, wherein the first and second planar exterior surfaces are perpendicular to the light path.

47. The apparatus of claim 45 wherein the first and second exterior surfaces are substantially parallel.

48. The apparatus of claim 47 wherein the first and second exterior surfaces are arranged substantially perpendicular to the light path.

49. The apparatus of claims 44-48 wherein the first and second fluid interfaces are substantially parallel.

50. The apparatus of claims 44-49 wherein the fluid handling manifold consists of a substantially transparent material having an index of refraction that is greater than the index of refraction of air.

51. The apparatus of claim 50 wherein the substantially transparent material has an index of refraction is greater than or equal to the reagent index of refraction.

52. The apparatus of claim 50 wherein the substantially transparent material has an index of refraction is greater than 1.4.

53. The apparatus of claim 50 wherein the substantially transparent material is selected from the group consisting of Lexan, acrylic, polycarbonate, Perspex, Lucite, Acrylite and polystyrene.

54. The apparatus of claims 44-53 wherein the light source is positioned to direct light at the first fluid interface surface at an angle of intersection greater than the critical reflectivity angle when air is present in the fluid conduit.

55. The apparatus of claims 44-54 wherein the angle of intersection of the light directed at the first interface surface results in less than about twenty percent (20%) of the light being reflected at the first interface surface when the reagent is present in the fluid conduit.

56. The apparatus of claims 44-55 further comprising a control system adapted to send/receive control signals to/from the light detector and the light source.

57. The apparatus of claim 56 wherein the control system is adapted to process the light generation signal and control an assay device.

58. A positive displacement pump comprising:
a pump chamber interface line from which the pump aspirates and dispenses fluid;
a first fluid line;
a second fluid line;
a 3-way valve having a first port, a second port and a common, port, wherein the first port is linked to the first fluid line, the second port is linked to the second fluid line and the common port is linked to the pump interface line, the 3-way valve being operable to place either the first fluid line or the second fluid line in fluid communication with the pump interface line;
a bypass line having a bypass shut-off valve, the bypass line being linked to the first fluid line and the second fluid line,
wherein the bypass shut-off valve is operable to selectively link the first fluid line and the second fluid line.

59. The positive displacement pump of claim 58 wherein the bypass valve, when open, allows the first and second fluid lines to be flushed without operation of the pump.

60. The positive displacement pump of claim 58 wherein-the first fluid line is an input line and the second fluid line is an output line.

61. A positive displacement pump having a pump chamber, the pump chamber comprising:
a first opening adapted to receive a pump piston;
a second opening from which the pump aspirates and dispenses fluid;
a pump chamber cleanout opening,
a cleanout plug for sealingly engaging the pump chamber cleanout opening,
wherein removal of the cleanout plug allows the pump chamber to be flushed without operation of the pump.

62. The positive displacement pump of claim 61, wherein the second opening and the pump chamber cleanout opening are spaced substantially at opposite ends of the pump chamber.

63. The positive displacement pump of claim 61, wherein the pump cleanout opening provides a fluid path that is substantially tangent to the interior wall of the pump chamber.

64. The positive displacement pump of claim 61, the first opening further comprising a fluidic seal between the pump piston and the first opening.

65. The positive displacement pump of claim 61 further comprising a piston.

66. A positive displacement pump having a pump chamber, the pump chamber comprising:
a first opening adapted to receive a pump piston;
a gas trap;
a sediment trap;
a first fluid line linked to the gas trap;
a-second fluid line linked to the sediment trap;
wherein the first and second fluid lines are sized relative to one another such that (i) the fluidic resistance of gas through the first fluid line is less than the fluidic resistance of liquid through the second fluid line, and (ii) the fluidic resistance of liquid through the first fluid line is greater than or equal to the fluidic resistance of liquid through the second fluid line.

67. The positive displacement pump, of claim 66, the first opening further comprising a fluidic seal between the pump piston and the first opening.

68. The positive displacement pump of claim 66, the gas trap is an angled groove along the top surface of the chamber and is arranged so that the first fluid line is linked to the topmost portion of the groove.

69. The positive displacement pump of claim 66, the sediment trap is an angled groove along the bottom surface of the chamber and is arranged so that the second fluid line is linked to the bottommost portion of the groove.

70. The positive displacement pump of claim 66, wherein the first and second fluid lines are directly connected to a single fluid interface line.

71. A method for retaining a plate wherein the plate may have any one of a plurality of different, predetermined flange heights, the method comprising translating the plate so that it engages
a first positioning block comprising a retractably mounted first positioning arm, the first positioning block having a first plurality of retaining ledges; and
a second positioning block having a second plurality of retaining ledges,
wherein at least one of the first plurality of retaining ledges is defined on the first positioning arm and the first and second positioning blocks are arranged to, engagingly receive the plate and the first arm is adapted to selectively apply a first biasing force upon the plate to position the plate under at least one of the second plurality of retaining ledges.

72. A method for positioning a plate in a predetermined plate alignment position, the method comprising:
placing the plate in a plate loader adapted to translate along a translation path;
translating said plate loader along said translation path;
engaging the plate with a first positioning block having a retractably mounted first positioning arm;
engaging the plate with a second positioning block;
aligning the plate against a plurality of plate positioning stops arranged in accordance with the predetermined plate alignment position;
wherein the plate loader is adapted to loosely receive the plate and translate the plate between the first, and second positioning blocks, the first and second positioning blocks being arranged to engagingly receive the plate, and
wherein the first positioning arm is adapted to selectively apply a first biasing force upon the plate to position the plate in the predetermined plate alignment position.

73. The method of claim 72 wherein said plurality of positioning stops are arranged on the plate loader.

74. The method of claim 71, the second positioning block further comprising a retractably mounted second positioning arm wherein at least one of the second plurality of retaining ledges is defined on the second positioning arm.

75. The method of claim 74, the first positioning block further comprising a retractably mounted third positioning arm wherein at least one other of the first plurality of retaining ledges is defined on the third positioning arm.

76. A method for positioning and retaining a plate in a predetermined plate alignment position, wherein the plate may have any one of a plurality of different predetermined flange heights, the method comprising:
placing the plate on a plate loader adapted to translate along a translation path and to loosely receive the plate;
translating the plate loader along the translation path;
engaging the plate with a first positioning block comprising a retractably mounted first positioning arm, the first positioning block having a first plurality of retaining ledges, at least one of the first plurality of retaining ledges being defined on the first positioning arm;
engaging the plate with a second positioning block having a second plurality of retaining ledges;
wherein the first positioning arm is adapted to selectively apply a first biasing force upon the plate to position the plate in the predetermined plate alignment position under at least one of the second plurality of retaining ledges.

77. A method for detecting proper alignment-of a plate, the comprising contacting the plate with a plate alignment detector comprising:
a sensor housing having arranged therein:
a sensor;
a first retractable lever arm having first and second lever ends; and
first and second spring members arranged between a housing surface and the first lever arm so as to apply biasing forces at the first and second lever ends, respectively,
wherein a properly positioned plate will contact each of the first and second lever ends and wherein the sensor is positioned in relation to the first lever arm so that each lever end must be displaced at least a predetermined distance by the plate in order to actuate the sensor.

78. A method for introducing reagents into a fluidic probe, the method comprising:
moving a probe having a probe tip and a probe sealing surface into a reagent manifold comprising:
an aspiration chamber having an access port, the aspiration chamber being defined within the reagent manifold;
a plurality of reagent input lines arranged at substantially the same height;
a gas input line arranged above the plurality of reagent input lines;
a reagent manifold sealing surface,
sealing the probe sealing surface against the reagent manifold sealing surface; and
aspirating gas or reagent from said gas input line or one of said plurality of reagent input lines.

79. The method according to claim 78 wherein said sealing is accomplished through a face seal.

80. The method according to claim 78 wherein the aspirating step comprises activation of a valve in said gas input line or said one of said plurality of reagent input lines.

81. A method for detecting the presence/absence of, a reagent having a reagent index of refraction, the comprising:
shining a beam of light through transparent light path defined in a fluid handling manifold having: (i) an exterior; (ii) a fluid conduit defined therein, wherein at least a portion of the fluid conduit comprises first and second planar fluid interface surfaces that intersect the light path; and
detecting light transmitted through-the fluid conduit
wherein the first and second fluid interface surfaces are arranged at fluid interface angles relative to the light path.

82. The method of claim 81 wherein said exterior of said fluid handling manifold has first and second exterior surfaces that intersect said light path, said first and second exterior surfaces being substantially parallel to each other and perpendicular to the light path.

83. The method of claims 81-82 wherein the angle of intersection of the light directed at the first interface surface is between 45-60 degrees.

84. The apparatus of claims 81-83 further comprising determining if said fluid conduit is filled with said reagent.

85. A method of cleaning a fluidic system comprising a positive displacement pump, the fluidic system comprising a:
a pump chamber interface line from which the pump aspirates and dispenses fluid;
a first fluid line;
a second fluid line;
a 3-way valve having a first port, a second port and a common port, wherein the first port is linked to the first fluid line, the second port is linked to the second fluid line and the common port is linked to the pump interface line, the 3-way valve being operable to place either the first fluid line or the second fluid line in fluid communication with the pump interface line;
a bypass line having a bypass shut-off valve, the bypass line being linked to the first fluid line and the second fluid line,
the method comprising
opening the bypass shut-off valve to link the first fluid line and the second fluid line.
flushing said first and second, fluid lines.

86. A method for cleaning the pump chamber of a seized positive displacement pump having a pump chamber, the pump chamber comprising:
a first opening adapted to receive a pump piston;
a second opening from which the pump aspirates and dispenses fluid;
a pump chamber cleanout opening,
a cleanout plug for sealingly engaging the pump chamber cleanout opening,
the method comprising removing the cleanout plug and flushing the pump chamber.

87. A method for pumping a liquid that may contain air bubbles and/or particulate matter, the method comprising:
introducing the liquid into the pump chamber of a positive displacement pump, the pump chamber comprising
a first opening adapted to receive a pump piston,
a gas trap,
a sediment trap,
a first fluid line linked to the gas trap,
a second fluid line linked to the sediment trap,
and a single fluid interface line directly connected to said first and second fluid line;
operating the pump for a first period of time during which any air in said gas trap is displaced through said first fluid line; and
operating the pump for a second period of time during which any sediment in said sediment trap is displaced through said second fluid line.
